(19) United States
(12) Patent Application Publication
(10) Pub. No.: US 2016/0300274 A1
(43) Pub. Date: Oct. 13, 2016

(54) PLATFORMS, SYSTEMS, METHODS, AND MEDIA FOR EVALUATING PRODUCTS, BUSINESSES, AND SERVICES

(71) Applicant: Michael Dolen, Manhattan Beach, CA (US)

(72) Inventor: Michael Dolen, Manhattan Beach, CA (US)

(21) Appl. No.: 14/681,739

(22) Filed: Apr. 8, 2015

(51) Int. Cl. G06Q 30/02; G06Q 50/00; G07C 13/00

(52) U.S. Cl. CPC G06Q 30/0282; G07C 13/00; G06Q 50/01

(57) ABSTRACT

Described herein are computer-implemented systems, platforms, methods and media to generate a weighted review score of a product, business, or service. The weighted review score includes at least one vote, said vote including at least one weight. When only one vote is provided, the weighted review score of the product, business, or service is based on the at least one weight. When a plurality of votes is provided, the weighted review score is a combination of one or more of the vote weights for one or more of the plurality of votes.

### BACKGROUND OF THE INVENTION

Reviews of products, businesses, and/or services influence consumers' willingness to purchase a product, use a product, visit a business, purchase a service, and/or use a service. A positive review will in some instances attract a prospective customer and/or user, and a negative review will in some instances dissuade a customer and/or user. Reviews of a person will in some instances influence willingness to trust, like, and/or interact with the person. A positive review will in some instances make one person more likely to trust, like and/or interact with the person being reviewed.

### SUMMARY OF THE INVENTION

As the internet matures, reviews, for example consumer reviews, of products, businesses, and services are becoming more prevalent. As a non-limiting example, before visiting a restaurant, a consumer will often visit a website such as Yelp or Urbanspoon in order to assess the “quality” of the restaurant based on its reviews. A positive review will likely attract a prospective customer, and a negative review will in some instances be powerful enough to dissuade the person from patronizing the restaurant. The increasing reliance of online reviews and ratings is empowering consumers to find the best products, businesses, services, people, places, and things. However the present system has at least one major flaw: reviews, regardless of who contributed them, are given equal mathematical rank when compiled together. In some embodiments, this results in distortion, for example, when a plurality of reviews are used to generate a rating of a product, business, or service. The inventor of the subject platforms, services, media, and methods described herein provides a novel solution to this flaw and thus provides a technical solution to this long-felt and unmet need.

In a first aspect, when an individual is dissatisfied with a particular product, business, or service, it is not uncommon for the individual to register multiple accounts in order to disparage the product, business, or service, respectively. In some embodiments, the person will sign-up for several accounts on the same website to leave multiple negative reviews for the product, business, or service. This gives the false appearance of a large number of unsatisfied customers. Furthermore, in some embodiments, the user provides a poor review (e.g., 1 star out of 5) from each of the multiple accounts, which distorts the average rating for the business, wherein the rating is generated based on a plurality of reviews. In a second aspect, an individual will follow the rules by signing up one account and leaving one review on a review website such as Yelp or Urbanspoon. However, this individual's indignation will spur them to repeat the process across several different, but similar review websites. This too provides the false appearance of a large number of unsatisfied customers. In a third aspect, an individual will act according to the first and second aspect by (1) signing up multiple accounts on the same website, and (2) repeating the process on multiple websites. In some embodiments, this results in a globalized negative perception. In some embodiments, rather than their grievance being isolated to one site, it is presented on the top 10 sites displayed in search engine rankings. As a non-limiting example, a user may search for a product, business, or service on a search engine and the snippets of text previews for each of the top 10 websites appear highly negative due to the same person leaving multiple negative reviews on multiple review websites. In some embodiments, without visiting the website of the product, business, or service, a person who sees such negative reviews will decide to not transact for the product, transact with the business, or transact for the service. Not only do the aforementioned review practices hurt consumers, they also harm product providers, businesses, and/or service providers. In some embodiments, this harm is exacerbated for small business owners, which rely heavily on review websites as a method for attracting new customers.

There is a long-felt and unmet need to solve the aforementioned review problem. While there is an existing method for highlighting specific reviews, which is implemented on some websites, this method is inefficient. As a non-limiting example, some websites allow users to vote one another user's review, for example with a thumbs up/thumbs down and/or an equivalent action (e.g., +1 or −1). In some embodiments, the more thumbs up a review receives, the higher it moves up in the displayed website page. This methodology is ineffective for at least the reasons stated below.

First, if one assumes there are two reviews of equal quality, one review is displayed at the top of the page, and the second review is displayed at the bottom. The review at the top is likely to generate more up votes (e.g., thumbs up, +1) than the review of identical quality at the bottom of the page. In some embodiments, this is because a review displayed higher up on the page is more likely to be seen by more people. In some embodiments, this creates a “snowball effect” in which the highest reviews continue to be the highest reviews—not necessarily because they are the most helpful or trustworthy, but rather because they continue to garner more attention due to being displayed higher up on the page. In some embodiments, a new review is more helpful and trustworthy, but because it is displayed farther down on the page, it receives little to no votes. This decreases the likelihood the more helpful and trustworthy review will be viewed by other consumers.

Second, voting a review up or down is an action based on only one variable: that specific review. It does not factor in other important variables, including but not limited to: (a) the total number of reviews from the user. Users who have only a few reviews on a given website may not be as trustworthy as those who may have provided hundreds or thousands of reviews. In some embodiments, a user who has only written one or a few reviews has an ulterior motive, for example to unscrupulously promote a product, business, or service they own or are affiliated with, for example by writing a positive review for the product, business, or service. In fact, this problem is so widespread that in 2009, the Federal Trade Commission issued new guidelines to combat—among other things—the inadequate disclosure of “material connections” in online reviews (See Federal Trade Commission, Guides Concerning the Use of Endorsements and Testimonials in Advertising, 16 CFR Part 255); (b) Review distributions of a user. In some embodiments, reviews provided by an honest and unbiased user will likely follow a normal distribution, for example, 15% of their reviews are 1 or 2 stars, 70% of their reviews are 3 and 4 stars, and 15% of their reviews are 5 stars. Patterns such as this closely resemble what the average person would consider to be real life experiences. However, if reviews from a user are skewed negative or positive, it demonstrates a negative or positive bias, respectively. As a non-limiting example, a user who rated 12 different Thai restaurants as being 5 stars demonstrates a positive bias, which is not very helpful if you are seeking to find the best among the 12. As another non-limiting example, a user who has written reviews that are all or mostly negative (e.g., 1 star out of 5) demonstrates a negative bias. As such, this user is likely not fair and balanced in their reviews and such negative reviews often contain controversial and inflammatory remarks about whom they are written about. The internet slang terminology for one who practices such behavior is known as a “troll” or a “flamer” (The Cambridge American English dictionary defines flamer as “someone who sends an angry or insulting email,” while Wikipedia defines a flamer as one “who [is] specifically motivated to incite flaming.”) While various definitions may differ slightly, it's generally agreed upon that trolls and/or flamers do not contribute constructive commentary and/or ratings within internet communities and their presence is one of the most frequented complaints amongst online user generated content. A website visitor who reads an individual review may not know if it's written by a troll or a flamer. To know if the review is provided by a troll or flamer, the pattern of the user providing the review should be analyzed; and (c) The length of time a user has been a participant. In some embodiments, the longer a user has been an active participant on a website, the less likely they are to have an ulterior motive (e.g., those attempting to unscrupulously promote their business often do so within a short period of time after joining).

The inventor of the subject matter described herein provides novel platforms, systems, methods, and media for compiling reviews for products, businesses, and service, wherein one or more reviews comprise one or more comments, one or more opinions, one or more emotions, one or more endorsements, one or more measured relationships, one or more measured connections, and/or one or more ratings. The inventor of the subject matter described herein provides novel platforms, systems, methods, and media for determining a weighted review score, a total weighted review score, and a rating from the compiled reviews of products, businesses, and services. The platform, systems, methods, and media provided herein provide a novel technical solution to the long-felt and unmet needs described herein.

In some aspects, provided herein are computer-implemented systems, media, methods, and platforms to generate a weighted review score of a product, business, or service, the computer-implemented systems, media, methods, and platforms comprising: a digital processing device comprising an operating system configured to perform executable instructions and a memory; a computer program including instructions executable by the digital processing device to create a review scoring application comprising: a software module configured to receive a review of a product, business, or service from a first user, the review comprising an evaluation of the product, business, or service; a software module configured to display the review; a software module configured to receive a vote on the review from a second user; a software module configured to assign the vote a plurality of vote weights, wherein the plurality of vote weights comprises at least one, some, or all of: a vote weight based on whether the second user previously reviewed the same or a similar product, business, or service; a vote weight based on a length of time since the second user reviewed the same or a similar product, business, or service; a vote weight based on a number of times the second user reviewed the same or a similar product, business, or service; a vote weight based on a percentage of votes submitted by the second user to the same or a similar product, business, or service; a vote weight based on a voting pattern or a review pattern of the second user; a vote weight based on a number of votes received by one or more additional reviews submitted by the second user; a vote weight based on a length of time the second user has been voting; a vote weight based on a frequency of votes submitted by the second user to the product, business, or service; a vote weight based on whether the second user is a verified user; and a vote weight based on a total number of votes submitted by the second user; and a software module configured to combine the plurality of vote weights to generate the weighted review score of the product, business, or service. In some embodiments, one or more of the plurality of vote weights are nested. In some embodiments, software module configured to receive a vote on the review from a second user is configured to receive a vote on the review from a plurality of users. In some embodiments, the software module configured to combine the plurality of vote weights to generate the weighted review score of the product, business, or service, combines the plurality of vote weights assigned to each vote to generate a weighted review score of each vote. In some embodiments, the systems, media, methods, and platforms comprise a software module configured to combine the weighted review score of each vote to generate a total weighted review score of the product, business, or service. In some embodiments, combining the weighted review score of each vote comprises applying a logarithmic function to at least a group of weighted review scores.

In some aspects, described herein are computer-implemented systems, media, methods, and platforms configured to generate a weighted review score of a product, business, or service, the computer-implemented systems, media, methods, and platforms comprising: a digital processing device comprising an operating system configured to perform executable instructions and a memory; a computer program including instructions executable by the digital processing device to create a review scoring application comprising: a software module configured to receive a review of a product, business, or service from a first user, the review comprising an evaluation of the product, business, or service; a software module configured to display the review; a software module configured to receive a vote on the review from a second user; a software module configured to assign the vote a vote weight; and a software module configured to generate the weighted review score of the product, business, or service based on the vote weight. In various embodiments, the vote weight comprises at least one, some, or all of: a vote weight based on whether the second user previously reviewed the same or a similar product, business, or service; a vote weight based on a length of time since the second user reviewed the same or a similar product, business, or service; a vote weight based on a number of times the second user reviewed the same or a similar product, business, or service; a vote weight based on a percentage of votes submitted by the second user to the same or similar product, business, or service; a vote weight based on a voting pattern or a review pattern of the second user; a vote weight based on a number of votes received by one or more additional reviews submitted by the second user; a vote weight based on a length of time the second user has been voting; a vote weight based on a frequency of votes submitted by the second user to the product, business, or service; a vote weight based on whether a measured relationship exists; a vote weight based on whether the second user is a verified user; and a vote weight based on a total number of votes submitted by the second user. In some embodiments, the software module configured to assign the vote a vote weight, assigns a plurality of vote weights to the vote. In some embodiments, the plurality of vote weights comprises at least one of: a vote weight based on whether the second user previously reviewed the same or a similar product, business, or service; a vote weight based on a length of time since the second user reviewed the same or a similar a similar product, business, or service; a vote weight based on a number of times the second user reviewed the same or a similar product, business, or service; a vote weight based on a percentage of votes submitted by the second user to the same or a similar product, business, or service; a vote weight based on a voting pattern or a review pattern of the second user; a vote weight based on a number of votes received by one or more additional reviews submitted by the second user; a vote weight based on a length of time the second user has been voting; a vote weight based on a frequency of votes submitted by the second user to the product, business, or service; a vote weight based on whether the second user is in a measured relationship; a vote weight based on whether the second user is a verified user; and a vote weight based on a total number of votes submitted by the second user. In some embodiments, one or more of the plurality of vote weights are nested. In some embodiments, the plurality of vote weights are combined to generate the weighted review score. In some embodiments, the software module configured to receive a vote on the review from a second user is configured to receive a vote on the review from a plurality of users. In some embodiments, the software module configured to assign the vote a vote weight, assigns each vote a vote weight. In some embodiments, the vote weight comprises at least one of: a vote weight based on whether a voting user previously reviewed the same or a similar product, business, or service; a vote weight based on a length of time since a voting user reviewed the same or a similar product, business, or service; a vote weight based on a number of times a voting user reviewed the same or a similar product, business, or service; a vote weight based on a percentage of votes submitted by a voting user to the same or a similar product, business, or service; a vote weight based on a voting pattern or a review pattern of a voting user; a vote weight based on a number of votes received by one or more additional reviews submitted by a voting user; a vote weight based on a length of time a voting user has been voting; a vote weight based on a frequency of votes submitted by a voting user to the product, business, or service; a vote weight based on whether a voting user is in a measured relationship; a vote weight based on whether a voting user is a verified user; and a vote weight based on a total number of votes submitted by a voting user. In some embodiments, the software module configured to generate the weighted review score of the product, business, or service, generates a weighted review score for each vote based on the vote weight. In some embodiments, the systems, media, methods, and platforms described herein comprise a software module configured to combine the weighted review score of each vote to generate a total weighted review score of the product, business, or service. In some embodiments, combining the weighted review score of each vote comprises applying a logarithmic function to at least a group of weighted review scores. In some embodiments, the software module configured to assign the vote a vote weight, assigns a plurality of vote weights to each vote received from the plurality of users. In some embodiments, the plurality of vote weights assigned to each vote comprises at least one of: a vote weight based on whether a voting user previously reviewed the same or a similar product, business, or service; a vote weight based on a length of time since a voting user reviewed the same or a similar product, business, or service; a vote weight based on a number of times a voting user reviewed the same or a similar product, business, or service; a vote weight based on a percentage of votes submitted by a voting user to the same or a similar product, business, or service; a vote weight based on a voting pattern or a review pattern of a voting user; a vote weight based on a number of votes received by one or more additional reviews submitted by a voting user; a vote weight based on a length of time a voting user has been voting; a vote weight based on a frequency of votes submitted by a voting user to the product, business, or service; a vote weight based on whether a voting user is in a measured relationship; a vote weight based on whether a voting user is a verified user; and a vote weight based on a total number of votes submitted by a voting user. In some embodiments, one or more of the plurality of vote weights are nested. In some embodiments, the plurality of vote weights are combined to generate the weighted review score for each vote. In some embodiments, the systems, media, methods, and platforms described herein comprise a software module configured to combine the weighted review score of each vote to generate a total weighted review score of the product, business, or service. In some embodiments, combining the weighted review score of each vote comprises applying a logarithmic function to at least a group of weighted review scores.

In some aspects, described herein are computer-implemented systems, media, methods, and platforms configured to generate a weighted review score of a product, business, or service, the computer-implemented systems, media, methods, and platforms comprising: a digital processing device comprising an operating system configured to perform executable instructions and a memory; a computer program including instructions executable by the digital processing device to create a review scoring application comprising: a software module configured to receive a review of a product, business, or service from a first user, the review comprising an evaluation of the product, business, or service; a software module configured to display the review; a software module configured to receive a vote on the review from a plurality of users; a software module configured to assign each vote received from the plurality of users a plurality of vote weights, wherein one or more of the plurality of vote weights are nested, and wherein the plurality of vote weights comprises at least one, some, or all of: a vote weight based on whether a voting user previously reviewed the same or a similar product, business, or service; a vote weight based on a length of time since a voting user reviewed the same or a similar product, business, or service; a vote weight based on a number of times a voting user reviewed the same or a similar product, business, or service; a vote weight based on a percentage of votes submitted by a voting user to the same or a similar product, business, or service; a vote weight based on a voting pattern or a review pattern of a voting user; a vote weight based on a number of votes received by one or more additional reviews submitted by a voting user; a vote weight based on a length of time a voting user has been voting; a vote weight based on a frequency of votes submitted by a voting user to the product, business, or service; a vote weight based on whether a voting user is a verified user; and a vote weight based on a total number of votes submitted by a voting user; a software module configured to combine the plurality of vote weights assigned to each vote received from the plurality of users to generate the weighted review score of the product, business, or service for each vote received from the plurality of users; and a software module configured to combine the weighted review score of each vote received from the plurality of users to generate a total weighted review score of the product, business, or service.

In some aspects, described herein are non-transitory computer-readable storage media encoded with a computer program including instructions executable by a processor to create a review scoring application to generate a weighted review score of a product, business, or service, the review scoring application comprising: a software module configured to receive a review of a product, business, or service from a first user, the review comprising an evaluation of the product, business, or service; a software module configured to display the review; a software module configured to receive a vote on the review from a second user; a software module configured to assign the vote a plurality of vote weights, wherein the plurality of vote weights comprises at least one, some, or all of: a vote weight based on whether the second user previously reviewed the same or a similar product, business, or service; a vote weight based on a length of time since the second user reviewed the same or a similar product, business, or service; a vote weight based on a number of times the second user reviewed the same or a similar product, business, or service; a vote weight based on a percentage of votes submitted by the second user to the same or a similar product, business, or service; a vote weight based on a voting pattern or a review pattern of the second user; a vote weight based on a number of votes received by one or more additional reviews submitted by the second user; a vote weight based on a length of time the second user has been voting; a vote weight based on a frequency of votes submitted by the second user to the product, business, or service; a vote weight based on whether the second user is a verified user; and a vote weight based on a total number of votes submitted by the second user; and a software module configured to combine the plurality of vote weights to generate the weighted review score of the product, business, or service. In some embodiments, one or more of the plurality of vote weights are nested. In some embodiments, the software module configured to receive a vote on the review from a second user is configured to receive a vote on the review from a plurality of users. In some embodiments, the software module configured to combine the plurality of vote weights to generate the weighted review score of the product, business, or service, combines the plurality of vote weights assigned to each vote to generate a weighted review score of each vote. In some embodiments, the application further comprises a software module configured to combine the weighted review score of each vote to generate a total weighted review score of the product, business, or service.

### BRIEF DESCRIPTION OF THE DRAWINGS

FIG. 1 is an illustration of a non-limiting example of the platforms, systems, methods and computer readable media described herein, for example assignment of influence/trust.

FIG. 2 is an illustration of a non-limiting example of the platforms, systems, methods and computer readable media described herein, for example calculating a weighted review score and a total weighted review score.

FIG. 3 is an illustration of a non-limiting example of the platforms, systems, methods and computer readable media described herein, for example nested vote weights.

### DETAILED DESCRIPTION OF THE INVENTION

In some aspects, provided herein are computer-implemented systems, media, methods, and platforms to generate a weighted review score of a product, business, or service, the computer-implemented systems, media, methods, and platforms comprising: a digital processing device comprising an operating system configured to perform executable instructions and a memory; a computer program including instructions executable by the digital processing device to create a review scoring application comprising: a software module configured to receive a review of a product, business, or service from a first user, the review comprising an evaluation of the product, business, or service; a software module configured to display the review; a software module configured to receive a vote on the review from a second user; a software module configured to assign the vote a plurality of vote weights, wherein the plurality of vote weights comprises at least one of: a vote weight based on whether the second user previously reviewed the same or a similar product, business, or service; a vote weight based on a length of time since the second user reviewed the same or a similar product, business, or service; a vote weight based on a number of times the second user reviewed the same or a similar product, business, or service; a vote weight based on a percentage of votes submitted by the second user to the same or a similar product, business, or service; a vote weight based on a voting pattern or a review pattern of the second user; a vote weight based on a number of votes received by one or more additional reviews submitted by the second user; a vote weight based on a length of time the second user has been voting; a vote weight based on a frequency of votes submitted by the second user to the product, business, or service; a vote weight based on whether the second user is a verified user; and a vote weight based on a total number of votes submitted by the second user; and a software module configured to combine the plurality of vote weights to generate the weighted review score of the product, business, or service.

In some aspects, described herein are computer-implemented systems, media, methods, and platforms configured to generate a weighted review score of a product, business, or service, the computer-implemented systems, media, methods, and platforms comprising: a digital processing device comprising an operating system configured to perform executable instructions and a memory; a computer program including instructions executable by the digital processing device to create a review scoring application comprising: a software module configured to receive a review of a product, business, or service from a first user, the review comprising an evaluation of the product, business, or service; a software module configured to display the review; a software module configured to receive a vote on the review from a second user; a software module configured to assign the vote a vote weight; and a software module configured to generate the weighted review score of the product, business, or service based on the vote weight.

In some aspects, described herein are computer-implemented systems, media, methods, and platforms configured to generate a weighted review score of a product, business, or service, the computer-implemented systems, media, methods, and platforms comprising: a digital processing device comprising an operating system configured to perform executable instructions and a memory; a computer program including instructions executable by the digital processing device to create a review scoring application comprising: a software module configured to receive a review of a product, business, or service from a first user, the review comprising an evaluation of the product, business, or service; a software module configured to display the review; a software module configured to receive a vote on the review from a plurality of users; a software module configured to assign each vote received from the plurality of users a plurality of vote weights, wherein one or more of the plurality of vote weights are nested, and wherein the plurality of vote weights comprises at least one of: a vote weight based on whether a voting user previously reviewed the same or a similar product, business, or service; a vote weight based on a length of time since a voting user reviewed the same or a similar product, business, or service; a vote weight based on a number of times a voting user reviewed the same or a similar product, business, or service; a vote weight based on a percentage of votes submitted by a voting user to the same or a similar product, business, or service; a vote weight based on a voting pattern or a review pattern of a voting user; a vote weight based on a number of votes received by one or more additional reviews submitted by a voting user; a vote weight based on a length of time a voting user has been voting; a vote weight based on a frequency of votes submitted by a voting user to the product, business, or service; a vote weight based on whether a voting user is a verified user; and a vote weight based on a total number of votes submitted by a voting user; a software module configured to combine the plurality of vote weights assigned to each vote received from the plurality of users to generate the weighted review score of the product, business, or service for each vote received from the plurality of users; and a software module configured to combine the weighted review score of each vote received from the plurality of users to generate a total weighted review score of the product, business, or service.

In some aspects, described herein are non-transitory computer-readable storage media encoded with a computer program including instructions executable by a processor to create a review scoring application to generate a weighted review score of a product, business, or service, the review scoring application comprising: a software module configured to receive a review of a product, business, or service from a first user, the review comprising an evaluation of the product, business, or service; a software module configured to display the review; a software module configured to receive a vote on the review from a second user; a software module configured to assign the vote a plurality of vote weights, wherein the plurality of vote weights comprises at least one of: a vote weight based on whether the second user previously reviewed the same or a similar product, business, or service; a vote weight based on a length of time since the second user reviewed the same or a similar product, business, or service; a vote weight based on a number of times the second user reviewed the same or a similar product, business, or service; a vote weight based on a percentage of votes submitted by the second user to the same or a similar product, business, or service; a vote weight based on a voting pattern or a review pattern of the second user; a vote weight based on a number of votes received by one or more additional reviews submitted by the second user; a vote weight based on a length of time the second user has been voting; a vote weight based on a frequency of votes submitted by the second user to the product, business, or service; a vote weight based on whether the second user is a verified user; and a vote weight based on a total number of votes submitted by the second user; and a software module configured to combine the plurality of vote weights to generate the weighted review score of the product, business, or service.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated. As used in this specification and the claims, unless otherwise stated, the term “about” refers to variations of +/−1%, +/−2%, +/−3%, +/−4%, +/−5%, +/−10%, +/−15%, or +/−25%, depending on the embodiment.

### Products, Businesses, and Services

In some embodiments, provided herein are platforms, systems, media, and methods to generate a weighted review score of a product, business, or service, or use of the same. In some embodiments, a product is a person. In some embodiments, the platforms, systems, media, and methods described herein, are configured to generate a weighted review score of a person. In some embodiments a review comprises a text-based review written by a user. In some embodiments a review comprises one or more opinions and/or one or more emotions of a user. In some embodiments, a review submitted by a first user evaluates a second user. In various embodiments a review submitted by a first user that evaluates a second user is based on the second user's review, voting, and/or endorsement history. In various embodiments, the second user is a group of people. As a non-limiting example, the second user comprises a family, a clique, a religious group, a social group, a social club, a professional group, a high school class, a grade school class, a college class.

In some embodiments, provided herein are platforms, systems, media, and methods to generate a weighted review score of a product, business, or service, or use of the same. In some embodiments, a product is a person. In some embodiments, the platforms, systems, media, and methods described herein, are configured to generate a weighted review score of a person. In some embodiments a review comprises a simple comment. In some embodiments, a review comprises a plurality of simple comments. As a non-limiting example, a simple comment comprises an emoticon (e.g., a smiley face). In various embodiments, an emoticon is a metacommunicative pictorial representation of a facial expression that, in the absence of body language and prosody, serves to draw a receiver's attention to the tenor or temper of a sender's nominal verbal communication, changing and improving its interpretation. In various embodiments, the patterns and distributions of simple comments are analyzed to determine whether the simple comment is useful.

In some embodiments, provided herein are platforms, systems, media, and methods to generate a weighted review score of a product, business, or service, or use of the same. In some embodiments, a product is a person. In some embodiments, the platforms, systems, media, and methods described herein, are configured to generate a weighted review score of a person. In some embodiments, a video and/or an image is analyzed to identify one or more persons emotion(s). In various embodiments, when a video is analyzed, one or more person's emotion(s) are analyzed at one time, a multiple times, and/or throughout the video. In various embodiments, one or more frames of a video are analyzed. In various embodiments, a person's emotion(s) are identified based on the person's facial expression(s), body language, gesture, or any other method of determining a person's emotion(s) from a video and/or an image. In various embodiments, a person's emotion(s) are identified based on the person's language and/or tone of voice. In various embodiments, a person's emotion(s) are identified based on audio. As a non-limiting example, audio comprises an audio recording, a song, and an annotated transcript of one or more verbal communications. In various embodiments, verbal communication comprises, talking, singing, yelling, humming, whispering, whistling, any noise made with a person's mouth, and any noise made with a person's vocal chords.

In some embodiments, provided herein are platforms, systems, media, and methods to generate a weighted review score of a product, business, or service, or use of the same. In some embodiments, a product is a person. In some embodiments, the platforms, systems, media, and methods described herein, are configured to generate a weighted review score of a person. In some embodiments a review comprises a text-based review written by a user. In some embodiments a review comprises one or more opinions and/or one or more emotions of a user. In some embodiments, a review and/or an evaluation comprise a review score, for example a score from 1 to 10, provided by a user. In various embodiments, a review score is selected from about 1 to about 2, from about 1 to about 3, from about 1 to about 4, from about 1 to about 5, from about 1 to about 6, from about 1 to about 7, from about 1 to about 8, from about 1 to about 9, from about 1 to about 10, from about 1 to about 12, from about 1 to about 15, from about 1 to about 18, from about 1 to about 20, from about 1 to about 25, from about 1 to about 30, from about 1 to about 35, from about 1 to about 40, from about 1 to about 45, from about 1 to about 50, from about 1 to about 60, from about 1 to about 70, from about 1 to about 80, from about 1 to about 90, from about 1 to about 100, and/or from about 1 to greater than about 100. In some embodiments a review score is a vote up or a vote down, a vote yes or a vote no, a vote “+” or a vote “−”, and/or any equivalent thereof that would allow a user to vote for or against a product, business, or service.

In some embodiments, provided herein are platforms, systems, media, and methods to generate a weighted review score of a product, business, or service, or use of the same. In some embodiments, the platforms, systems, methods and media described herein are used for consumers to review products, businesses and/or services. In some embodiments, the platforms, systems, methods, and media described herein are used for businesses to review other businesses, for example in a business-to-business relationship. In various embodiments, when the platforms, systems, methods and media are used in a business-to-business relationship, the reviews and/or review scores are provided by employees of at least one business.

In some embodiments, provided herein are platforms, systems, media, and methods to generate a weighted review score of a product, business, or service, or use of the same. In some embodiments, the product comprises a consumer product, a consumer good, and/or a final good. In some embodiments, examples of consumer products, consumer goods and/or firm goods comprise consumer electronics, music players, TVs, smart phones, clothing, children's toys, and handbags. In some embodiments, a product comprises a shopping product, for example a car, a house, and a laptop. In some embodiments, a product comprises a specialty product, for example a men's suit, women's designer handbags, expensive watches, and expensive wine. In some embodiments, a product is an unsought good, for example a fire extinguisher, an encyclopedia, and life insurance. In some embodiments a product comprises a business product, for example crude oil, wood, machinery, photocopiers, and paper. In some embodiments a product comprises an industrial product. In some embodiments, a product comprises a mutual fund, an exchange-traded fund, a savings account, a membership, and a subscription.

In some embodiments, provided herein are platforms, systems, media, and methods to generate a weighted review score of a product, business, or service, or use of the same. In some embodiments, the business comprises a restaurant, a bar, a nightclub, a beauty salon, a real estate company/agent, a tax accounting firm, a legal services firm, a hardware store, a church, a pharmacy, a healthcare provider, a physician, a hospital, an auto repair shop, an auto body shop, a clothing store, and any retail store. In various embodiments, the business is an airline, a hotel, and/or a rental car company. In various embodiments, the business comprises a theater and a museum. In various embodiments, the business comprises a non-profit corporation, for example, a charity. In various embodiments, the business is a small business.

In some embodiments, provided herein are platforms, systems, media, and methods to generate a weighted review score of a product, business, or service, or use of the same. In some embodiments, the business comprises a large corporation, for example JPMorgan Chase, Berkshire Hathaway, Exxon Mobil, General Electric, Wells Fargo, Bank of America, Apple, Citigroup, Chevron, Proctor & Gamble, Google, Apple, Wal-Mart Stores, AT&T, Verizon Communications, Microsoft, IBM, Procter & Gamble, Johnson & Johnson, American International Group, Pfizer, Ford Motor, Google, Comcast Goldman Sachs Group, General Motors, MetLife, Conoco Phillips, Intel, Hewlett-Packard, Coca-Cola, Cisco Systems, UnitedHealth Group, Boeing, PepsiCo, Oracle, and/or any other large corporation. In various embodiments, the business is a publically traded corporation.

In some embodiments, provided herein are platforms, systems, media, and methods to generate a weighted review score of a product, business, or service, or use of the same. In various embodiments, the business is a private corporation. In various embodiments, a private corporation further comprises an LLC, an LP, a PLLC, a partnership, a MLP, and any business entity legal definition. In various embodiments, the business is a public corporation. In various embodiments, a public corporation further comprises an LLC, an LP, a PLLC, a partnership, a MLP, and any business entity legal definition.

In some embodiments, provided herein are platforms, systems, media, and methods to generate a weighted review score of a product, business, or service, or use of the same. In some embodiments, the service comprises plumbing, electrical work (i.e., work conducted by an electrician or an equivalent thereof), heating and cooling, window washing, construction, remodeling, decorating, cleaning, salon services, real estate services, financial advising, photography, videography, and legal services. In various embodiments, the service is provided by a business. In various embodiments, the service is provided by a small business.

In some embodiments, provided herein are platforms, systems, media, and methods to generate a weighted review score of a product, business, or service, or use of the same. In various embodiments the business is a healthcare provider. As a non-limiting example, a healthcare provider comprises a physician, a hospital, an urgent care clinic, a surgeon, a plastic surgeon, a psychologist, a chiropractor, and a physical therapist. In various embodiments, the service is provided by a healthcare provider. As a non-limiting example, the service provided by a healthcare provider comprises a medical service, an elective medical service, a dental service, an orthodontic service, a mental health service, a chiropractic service, and a physical rehabilitation service. In various embodiments the business participates in providing wellness products. As a non-limiting example, a wellness product comprises a vitamin, an essential oil, and a wellness food. In various embodiments, a service is a wellness service. As a non-limiting example, a wellness service comprises a nutrition service, a work-life balance service, and an exercise counseling service.

In some embodiments, provided herein are platforms, systems, media, and methods to generate a weighted review score of a product, business, or service, or use of the same. In some embodiments, the platforms, systems, media, and methods described herein, are configured to generate a weighted review score of a person who currently or formerly works at a business, for example, one or more of the businesses or entities described herein. In some embodiments, the platforms, systems, media, and methods described herein, are configured to generate a weighted review score of a person who currently and/or formerly is associated with a business, for example, one or more of the businesses or entities described herein.

In some embodiments, provided herein are platforms, systems, media, and methods to generate a weighted review score of a product, business, or service, or use of the same. In some embodiments, a product is a person. In some embodiments, when the product is a person, the person behaves like a person who is a product. In some embodiments, when the product is a person, the person does not behave like a person who is a product. In various embodiments, a person who behaves like a product provides a benefit to another person, for example, a material benefit, an emotional benefit, a physical benefit. In various embodiments, a person who behaves like a product does not provide a benefit to another person, for example, a material benefit, an emotional benefit, a physical benefit. In various embodiments, a person who behaves like a product will never provide a benefit to another person, for example, a material benefit, an emotional benefit, a physical benefit. In various embodiments, a person who does not behave like a person who is a product provides a benefit to another person, for example, a material benefit, an emotional benefit, a physical benefit. In various embodiments, a person who does not behave like a person who is a product does not provide a benefit to another person, for example, a material benefit, an emotional benefit, a physical benefit. In various embodiments, a person who does not behave like a person who is a product will never provide a benefit to another person, for example, a material benefit, an emotional benefit, a physical benefit. In various embodiments a person provides a physical and/or emotional benefit to the user providing the review. In various embodiments a person provides a physical and/or emotional detriment to the user providing the review. In various embodiments a person does not provide a physical and/or emotional benefit and/or detriment to the user providing the review. In various embodiments a person will never provide a physical and/or emotional benefit and/or detriment to the user providing the review. In various embodiments, the user has never interacted with the person. In various embodiments, the user reviews a person with whom the user has interacted. In various embodiments, interacting with a person comprises at least one of seeing a person, talking to a person, meeting a person, and shaking hands with a person. In various embodiments, a person provides a review, vote, and/or endorsement of himself/herself. In some embodiments, a product is a person, for example a celebrity, a politician, a pundit, a newscaster, a TV and/or radio show host, a teacher, a professor, an event planner, a photographer, an attorney, a real estate agent, a financial advisor, a beautician, a musician, an athlete, a waiter, a chauffeur, a chef, a pastor, a business executive, an employee, a newsworthy figure, a famous person, and a non-famous person. In various embodiments, a person is a plurality of persons that are reviewed as one group, for example, a band, a sports team, a political party, and a cast of a movie. In various embodiments, a person is a “normal” and/or non-famous person. Non-limiting examples of “normal” persons comprise a current friend, a former friend, an acquaintance, a current professor/teacher, a former professor/teacher, a current student, a former student, a co-worker, a former co-worker, a classmate, a former classmate, a neighbor, a former neighbor, a relative, a current girlfriend, a former girlfriend, a current wife, a former wife, a current boyfriend, a former boyfriend, a current husband, and a former husband. In various embodiments, a “normal” person is a plurality of persons that are reviewed as one group, for example, a family, a clique, a religious group, a social group, a social club, a professional group, a high school class, a grade school class, and a college class.

In some embodiments, provided herein are platforms, systems, media, and methods to generate a weighted review score of a product, business, or service, or use of the same. In some embodiments, the platforms, systems, media, and methods described herein, are configured to generate a weighted review score of a person. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product. In various embodiments, a person who behaves like a product provides a benefit to another person, for example, a material benefit, an emotional benefit, a physical benefit. In various embodiments, a person who behaves like a product does not provide a benefit to another person, for example, a material benefit, an emotional benefit, a physical benefit. In various embodiments, a person who behaves like a product will never provide a benefit to another person, for example, a material benefit, an emotional benefit, a physical benefit. In various embodiments, a person who does not behave like a person who is a product provides a benefit to another person, for example, a material benefit, an emotional benefit, a physical benefit. In various embodiments, a person who does not behave like a person who is a product does not provide a benefit to another person, for example, a material benefit, an emotional benefit, a physical benefit. In various embodiments, a person who does not behave like a person who is a product will never provide a benefit to another person, for example, a material benefit, an emotional benefit, a physical benefit. In various embodiments a person provides a physical and/or emotional benefit to the user providing the review. In various embodiments a person provides a physical and/or emotional detriment to the user providing the review. In various embodiments a person does not provide a physical and/or emotional benefit and/or detriment to the user providing the review. In various embodiments a person will never provide a physical and/or emotional benefit and/or detriment to the user providing the review. In various embodiments, the user has never interacted with the person. In various embodiments, the user reviews a person with whom the user has interacted. In various embodiments, interacting with a person comprises at least one of seeing a person, talking to a person, meeting a person, shaking hands with a person. In various embodiments, a person provides a review, vote, opinion, emotion, and/or endorsement of himself/herself. In various embodiments the person is a celebrity, a politician, a pundit, a newscaster, a TV and/or radio show host, a teacher, a professor, an event planner, a photographer, an attorney, a real estate agent, a financial advisor, a beautician, a musician, an athlete, a waiter, a chauffeur, a chef, a pastor, a business executive, an employee, a newsworthy figure, and a non-famous person. In various embodiments, a person is a plurality of persons that are reviewed as one group, for example, a band, a sports team, a political party, and a cast of a movie. In various embodiments, a person is a “normal” and/or non-famous person. Non-limiting examples of “normal” persons comprise a current friend, a former friend, an acquaintance, a current professor/teacher, a former professor/teacher, a current student, a former student, a co-worker, a former co-worker, a classmate, a former classmate, a neighbor, a former neighbor, a relative, a current girlfriend, a former girlfriend, a current wife, a former wife, a current boyfriend, a former boyfriend, a current husband, and a former husband.

In some embodiments, provided herein are platforms, systems, media, and methods to generate a weighted review score of a product, business, or service, or use of the same. In some embodiments, a business and/or service comprises a government-run facility, for example a park, a state park, a national park, a public and/or private school, a Department of Motor Vehicles and any other government run business, service and/or entity. In some embodiments, a business comprises a neighborhood, a city, a region, and a country. In some embodiments, the platforms, systems, media, and methods described herein, are configured to generate a weighted review score of a person who currently or formerly works at a business, for example, one or more of the aforementioned businesses. In some embodiments, the platforms, systems, media, and methods described herein, are configured to generate a weighted review score of a person who currently and/or formerly is associated with a business, for example, one or more of the aforementioned businesses.

### Weights and Weighting Methods

In some embodiments, provided herein are platforms, systems, media, and methods to assign one or more votes of a review one or more vote weights, or use of the same. In some embodiments, a first user is the user providing the review. In some embodiments, a review comprises one or more comments, one or more opinions, one or more emotions, one or more endorsements, one or more measured relationships, one or more measured connections, and/or one or more ratings. In some embodiments, a second user is the user providing the vote. In some embodiments a plurality of users each provide one or more votes to the review. In some embodiments, the software module configured to receive a vote on the review from a second user is configured to receive a vote on the review from one or more of a plurality of users. In some embodiments, a vote is a comment, an opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user.

In some embodiments, provided herein are platforms, systems, media, and methods to assign one or more votes of a review one or more vote weights, or use of the same. In some embodiments, a vote is a comment, an opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user. In some embodiments the vote is assigned one vote weight. In some embodiments the vote is assigned two vote weights. In further or additional embodiments, one or more of the vote weights are the same. In further or additional embodiments, one or more of the vote weights are different. In some embodiments the vote is assigned three vote weights. In further or additional embodiments, one or more of the vote weights are the same. In further or additional embodiments, one or more of the vote weights are different. In some embodiments the vote is assigned four vote weights. In further or additional embodiments, one or more of the vote weights are the same. In further or additional embodiments, one or more of the vote weights are different. In some embodiments the vote is assigned five vote weights. In further or additional embodiments, one or more of the vote weights are the same. In further or additional embodiments, one or more of the vote weights are different. In some embodiments the vote is assigned six vote weights. In further or additional embodiments, one or more of the vote weights are the same. In further or additional embodiments, one or more of the vote weights are different. In some embodiments the vote is assigned seven vote weights. In further or additional embodiments, one or more of the vote weights are the same. In further or additional embodiments, one or more of the vote weights are different. In some embodiments the vote is assigned eight vote weights. In further or additional embodiments, one or more of the vote weights are the same. In further or additional embodiments, one or more of the vote weights are different. In some embodiments the vote is assigned nine vote weights. In further or additional embodiments, one or more of the vote weights are the same. In further or additional embodiments, one or more of the vote weights are different. In some embodiments the vote is assigned ten vote weights. In further or additional embodiments, one or more of the vote weights are the same. In further or additional embodiments, one or more of the vote weights are different. In some embodiments the vote is assigned a plurality of vote weights. In further or additional embodiments, one or more of the vote weights are the same. In further or additional embodiments, one or more of the vote weights are different.

In some embodiments, provided herein are platforms, systems, media, and methods to assign one or more votes of a review one or more vote weights, or use of the same. In some embodiments, a vote is a comment, an opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user. In some embodiments, a plurality of users vote on a review, thereby providing a plurality of votes. In various embodiments, one or more of the plurality of votes is assigned one vote weight. In further or additional embodiments, one or more of the vote weights are the same. In further or additional embodiments, one or more of the vote weights are different. In various embodiments, one or more of the plurality of votes is assigned two vote weights. In further or additional embodiments, one or more of the vote weights are the same. In further or additional embodiments, one or more of the vote weights are different. In various embodiments, one or more of the plurality of votes is assigned three vote weights. In further or additional embodiments, one or more of the vote weights are the same. In further or additional embodiments, one or more of the vote weights are different. In various embodiments, one or more of the plurality of votes is assigned four vote weights. In further or additional embodiments, one or more of the vote weights are the same. In further or additional embodiments, one or more of the vote weights are different. In various embodiments, one or more of the plurality of votes is assigned five vote weights. In further or additional embodiments, one or more of the vote weights are the same. In further or additional embodiments, one or more of the vote weights are different. In various embodiments, one or more of the plurality of votes is assigned six vote weights. In further or additional embodiments, one or more of the vote weights are the same. In further or additional embodiments, one or more of the vote weights are different. In various embodiments, one or more of the plurality of votes is assigned seven vote weights. In further or additional embodiments, one or more of the vote weights are the same. In further or additional embodiments, one or more of the vote weights are different. In various embodiments, one or more of the plurality of votes is assigned eight vote weights. In further or additional embodiments, one or more of the vote weights are the same. In further or additional embodiments, one or more of the vote weights are different. In various embodiments, one or more of the plurality of votes is assigned nine vote weights. In further or additional embodiments, one or more of the vote weights are the same. In further or additional embodiments, one or more of the vote weights are different. In various embodiments, one or more of the plurality of votes is assigned ten vote weights. In further or additional embodiments, one or more of the vote weights are the same. In further or additional embodiments, one or more of the vote weights are different. In various embodiments, one or more of the plurality of votes is assigned a plurality of vote weights. In further or additional embodiments, one or more of the vote weights are the same. In further or additional embodiments, one or more of the vote weights are different. In some embodiments, one or more of the plurality of votes are assigned the same or different number of vote weights, the vote weights corresponding to the aforementioned embodiments. In various embodiments, one or more of the vote weights are the same. In various embodiments, one or more of the vote weights are different.

In some embodiments, provided herein are platforms, systems, media, and methods to assign one or more votes of a review one or more vote weights, or use of the same. In some embodiments, a vote is assigned 1 vote weight, about 2 vote weights, about 3 vote weights, about 4 vote weights, about 5 vote weights, about 6 vote weights, about 7 vote weights, about 8 vote weights, about 9 vote weights, about 10 vote weights, about 12 vote weights, about 15 vote weights, about 18 vote weights, about 20 vote weights, about 25 vote weights, about 30 vote weights, about 35 vote weights, about 40 vote weights, about 45 vote weights, about 50 vote weights, about 60 vote weights, about 70 vote weights, about 80 vote weights, about 90 vote weights, about 100 vote weights, about 125 vote weights, about 150 vote weights, about 175 vote weights, about 200 vote weights, about 250 vote weights, about 300 vote weights, about 350 vote weights, about 400 vote weights, about 450 vote weights, about 500 vote weights, about 600 vote weights, about 700 vote weights, about 800 vote weights, about 900 vote weights, about 1000 vote weights, about 1250 vote weights, about 1500 vote weights, about 1750 vote weights, about 2000 vote weights, about 2500 vote weights, about 3000 vote weights, about 3500 vote weights, about 4000 vote weights, about 4500 vote weights, about 5000 vote weights, about 6000 vote weights, about 7000 vote weights, about 8000 vote weights, about 9000 vote weights, about 10,000 vote weights, about 12,500 vote weights, about 15,000 vote weights, about 17,500 vote weights, about 20,000 vote weights, about 25,000 vote weights, about 30,000 vote weights, about 35,000 vote weights, about 40,000 vote weights, about 45,000 vote weights, about 50,000 vote weights, about 60,000 vote weights, about 70,000 vote weights, about 80,000 vote weights, about 90,000 vote weights, about 100,000 vote weights, about 125,000 vote weights, about 150,000 vote weights, about 175,000 vote weights, about 200,000 vote weights, about 250,000 vote weights, about 300,000 vote weights, about 350,000 vote weights, about 400,000 vote weights, about 450,000 vote weights, about 500,000 vote weights, about 600,000 vote weights, about 700,000 vote weights, about 800,000 vote weights, about 900,000 vote weights, about 1,000,000 vote weights, about 1,250,000 vote weights, about 1,500,000 vote weights, about 1,750,000 vote weights, about 2,000,000 vote weights, about 2,500,000 vote weights, about 3,000,000 vote weights, about 3,500,000 vote weights, about 4,000,000 vote weights, about 4,500,000 vote weights, about 5,000,000 vote weights, about 6,000,000 vote weights, about 7,000,000 vote weights, about 8,000,000 vote weights, about 9,000,000 vote weights, about 10,000,000 vote weights, about 12,500,000 vote weights, about 15,000,000 vote weights, about 17,500,000 vote weights, about 20,000,000 vote weights, about 25,000,000 vote weights, about 30,000,000 vote weights, about 35,000,000 vote weights, about 40,000,000 vote weights, about 45,000,000 vote weights, about 50,000,000 vote weights, about 60,000,000 vote weights, about 70,000,000 vote weights, about 80,000,000 vote weights, about 90,000,000 vote weights, about 100,000,000 vote weights, about 125,000,000 vote weights, about 150,000,000 vote weights, about 175,000,000 vote weights, about 200,000,000 vote weights, about 250,000,000 vote weights, about 300,000,000 vote weights, about 350,000,000 vote weights, about 400,000,000 vote weights, about 450,000,000 vote weights, about 500,000,000 vote weights, about 600,000,000 vote weights, about 700,000,000 vote weights, about 800,000,000 vote weights, about 900,000,000 vote weights, about 1,000,000,000, or greater than about 1,000,000,000. In some embodiments, when a vote is assigned more than one vote weight, the contribution of each vote weight to the weighted review score is the same. In some embodiments, when a vote is assigned more than one vote weight, the contribution of each vote weight to the weighted review score is different.

In some embodiments, provided herein are platforms, systems, media, and methods to assign one or more votes of a review one or more vote weights, or use of the same. In some embodiments, a vote weight is based on whether the user providing the vote previously reviewed the product, business or service. In some embodiments, the vote weight increases when the user providing the vote previously reviewed the same or a similar product, business or service. In various embodiments, the vote weight further increases when the user providing the vote previously reviewed the same or similar product, business, or service. In various embodiments, a similar product is based on the product category. In various embodiments, a similar business is based on the market sector to which the business being reviewed belongs. In various embodiments, a business is similar if it is in the same geographical region as the business being reviewed. In various embodiments, a geographical region is the same neighborhood, zip code, village, town, city, county, state, and/or country. In various embodiments, a similar service is based on the market sector to which the service being reviewed belongs. In various embodiments, a service is similar if it is in the same geographical region as the business being reviewed. In various embodiments, a geographical region is the same neighborhood, zip code, village, town, city, county, state, and/or country.

In some embodiments, provided herein are platforms, systems, media, and methods to assign one or more votes of a review one or more vote weights, or use of the same. In some embodiments, a user submits a review directed to a person. In various embodiments, a product is a person. In some embodiments, when the product is a person, the person behaves like a person who is a product. In some embodiments, when the product is a person, the person does not behave like a person who is a product. In some embodiments, a vote weight is based on whether the user providing the vote previously reviewed the person. In some embodiments, the vote weight increases when the user providing the vote previously reviewed the same or a similar person. In some embodiments, the vote weight increases when the user providing the vote previously reviewed the same or similar groups of persons. In various embodiments, a similar person or similar groups of persons is based on characteristics of the person being reviewed. In various embodiments, similar characteristics comprise, sex, age, race, religion, political affiliation, hobbies, education level, citizenship, culture, and lineage. In various embodiments, a person is similar if it he/she in the same geographical region as the person being reviewed. In various embodiments, a geographical region is the same neighborhood, zip code, village, town, city, county, state, and/or country.

In some embodiments, provided herein are platforms, systems, media, and methods to assign one or more votes of a review one or more vote weights, or use of the same. In some embodiments, a vote weight is based on a length of time since the user providing the vote has reviewed the same or a similar product, business, or service. In some embodiments, a product is a person. In some embodiments, when the product is a person, the person behaves like a person who is a product. In some embodiments, when the product is a person, the person does not behave like a person who is a product. In some embodiments, the vote weight increases when the user providing the vote previously reviewed the same or a similar product, business or service within about 1 minute, 2 minutes, 3 minutes, 4 minutes, about 5 minutes, about 6 minutes, about 7 minutes, about 8 minutes, about 9 minutes, about 10 minutes, about 15 minutes, about 20 minutes, about 25 minutes, about 30 minutes, about 35 minutes, about 40 minutes, about 50 minutes, about 1 hour, about 2 hours, 3 hours, 4 hours, about 5 hours, about 6 hours, about 7 hours, about 8 hours, about 9 hours, about 10 hours, about 15 hours, about 20 hours, about 1 day, about 2 days, about 3 days, about 4 days, about 5 days, about 6 days, about 1 week, about 2 weeks, about 3 weeks, about 1 month, about 2 months, about 3 months, about 4 months, about 5 months, about 6 months, about 7 months, about 8 months, about 9 months, about 10 months, about 11 months, about 1 year, about 2 years, about 3 years, about 4 years, about 5 years, about 6 years, about 7 years, about 8 years, about 9 years, about 1 decade, or greater than 1 decade. In various embodiments, the vote weight further increases when the user providing the vote previously reviewed the same product, business, or service. In various embodiments, a similar product is based on the product category. In various embodiments, a similar business is based on the market sector to which the business being reviewed belongs. In various embodiments, a business is similar if it is in the same geographical region as the business being reviewed. In various embodiments, a geographical region is the same neighborhood, zip code, village, town, city, county, state, and/or country. In various embodiments, a similar service is based on the market sector to which the service being reviewed belongs. In various embodiments, a service is similar if it is in the same geographical region as the business being reviewed. In various embodiments, a geographical region is the same neighborhood, zip code, village, town, city, county, state, and/or country.

In some embodiments, provided herein are platforms, systems, media, and methods to assign one or more votes of a review one or more vote weights, or use of the same. In some embodiments, a vote weight is based on a length of time since the user providing the vote has reviewed the same or a similar person. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product. In some embodiments, the vote weight increases when the user providing the vote previously reviewed the same or a similar person within about 1 minute, 2 minutes, 3 minutes, 4 minutes, about 5 minutes, about 6 minutes, about 7 minutes, about 8 minutes, about 9 minutes, about 10 minutes, about 15 minutes, about 20 minutes, about 25 minutes, about 30 minutes, about 35 minutes, about 40 minutes, about 50 minutes, about 1 hour, about 2 hours, 3 hours, 4 hours, about 5 hours, about 6 hours, about 7 hours, about 8 hours, about 9 hours, about 10 hours, about 15 hours, about 20 hours, about 1 day, about 2 days, about 3 days, about 4 days, about 5 days, about 6 days, about 1 week, about 2 weeks, about 3 weeks, about 1 month, about 2 months, about 3 months, about 4 months, about 5 months, about 6 months, about 7 months, about 8 months, about 9 months, about 10 months, about 11 months, about 1 year, about 2 years, about 3 years, about 4 years, about 5 years, about 6 years, about 7 years, about 8 years, about 9 years, about 1 decade, or greater than 1 decade. In various embodiments, the vote weight further increases when the user providing the vote previously reviewed the same person. In various embodiments, a person is similar if the person is in the same geographical region as the person being reviewed. In various embodiments, a geographical region is the same neighborhood, zip code, village, town, city, county, state, and/or country.

In some embodiments, provided herein are platforms, systems, media, and methods to assign one or more votes of a review one or more vote weights, or use of the same. In some embodiments, a vote weight is based on a total number of reviews a user has contributed. In some embodiments, the weight increases when the user providing the vote has contributed a large number of reviews. In various embodiments, a large number of reviews is about 1, about 2, about 3, about 4, about 5, about 6, about 7, about 8, about 9, about 10, about 15, about 20, about 25, about, 30, about 35, about 40, about 50, about 60, about 70, about 80, about 90, about 100, about 125, about 150, about 175, about 200, about 250, about 300, about 350, about 400, about 450, about 500, about 600, about 700, about 800, about 900, about 1000, about 1250, about 1500, about 1750, about 2000, about 2500, about 3000, about 3500, about 4000, about 4500, about 5000, about 6000, about 7000, about 8000, about 9000, about 10,000, about 12,500, about 15,000, about 17,500, about 20,000, about 25,000, about 30,000, about 35,000, about 40,000, about 45,000, about 50,000, about 60,000, about 70,000, about 80,000, about 90,000, about 100,000, about 125,000, about 150,000, about 175,000, about 200,000, about 250,000, about 300,000, about 350,000, about 400,000, about 450,000, about 500,000, about 600,000, about 700,000, about 800,000, about 900,000, about 1,000,000, about 1,250,000, about 1,500,000, about 1,750,000, about 2,000,000, about 2,500,000, about 3,000,000, about 3,500,000, about 4,000,000, about 4,500,000, about 5,000,000, about 6,000,000, about 7,000,000, about 8,000,000, about 9,000,000, about 10,000,000, about 12,500,000, about 15,000,000, about 17,500,000, about 20,000,000, about 25,000,000, about 30,000,000, about 35,000,000, about 40,000,000, about 45,000,000, about 50,000,000, about 60,000,000, about 70,000,000, about 80,000,000, about 90,000,000, about 100,000,000, about 125,000,000, about 150,000,000, about 175,000,000, about 200,000,000, about 250,000,000, about 300,000,000, about 350,000,000, about 400,000,000, about 450,000,000, about 500,000,000, about 600,000,000, about 700,000,000, about 800,000,000, about 900,000,000, about 1,000,000,000, or greater than about 1,000,000,000.

In some embodiments, provided herein are platforms, systems, media, and methods to assign one or more votes of a review one or more vote weights, or use of the same. In some embodiments, a vote weight is based on a total number of reviews a user has contributed. In some embodiments, the weight decreases when the user providing the vote has contributed a small number of reviews. In various embodiments, a small number of reviews is less than about 1, less than about 2, less than about 3, less than about 4, less than about 5, less than about 6, less than about 7, less than about 8, less than about 9, less than about 10, less than about 15, less than about 20, less than about 25, less than about, 30, less than about 35, less than about 40, less than about 50, less than about 60, less than about 70, less than about 80, less than about 90, less than about 100, less than about 125, less than about 150, less than about 175, less than about 200, less than about 250, less than about 300, less than about 350, less than about 400, less than about 450, less than about 500, less than about 600, less than about 700, less than about 800, less than about 900, less than about 1000, less than about 1250, less than about 1500, less than about 1750, less than about 2000, less than about 2500, less than about 3000, less than about 3500, less than about 4000, less than about 4500, less than about 5000, less than about 6000, less than about 7000, less than about 8000, less than about 9000, less than about 10,000, less than about 12,500, less than about 15,000, less than about 17,500, less than about 20,000, less than about 25,000, less than about 30,000, less than about 35,000, less than about 40,000, less than about 45,000, less than about 50,000, less than about 60,000, less than about 70,000, less than about 80,000, less than about 90,000, less than about 100,000, less than about 125,000, less than about 150,000, less than about 175,000, less than about 200,000, less than about 250,000, less than about 300,000, less than about 350,000, less than about 400,000, less than about 450,000, less than about 500,000, less than about 600,000, less than about 700,000, less than about 800,000, less than about 900,000, less than about 1,000,000, less than about 1,250,000, less than about 1,500,000, less than about 1,750,000, less than about 2,000,000, less than about 2,500,000, less than about 3,000,000, less than about 3,500,000, less than about 4,000,000, less than about 4,500,000, less than about 5,000,000, less than about 6,000,000, less than about 7,000,000, less than about 8,000,000, less than about 9,000,000, less than about 10,000,000, less than about 12,500,000, less than about 15,000,000, less than about 17,500,000, less than about 20,000,000, less than about 25,000,000, less than about 30,000,000, less than about 35,000,000, less than about 40,000,000, less than about 45,000,000, less than about 50,000,000, less than about 60,000,000, less than about 70,000,000, less than about 80,000,000, less than about 90,000,000, less than about 100,000,000, less than about 125,000,000, less than about 150,000,000, less than about 175,000,000, less than about 200,000,000, less than about 250,000,000, less than about 300,000,000, less than about 350,000,000, less than about 400,000,000, less than about 450,000,000, less than about 500,000,000, less than about 600,000,000, less than about 700,000,000, less than about 800,000,000, less than about 900,000,000, less than about 1,000,000,000, or less than about 1,000,000,000,000.

In some embodiments, provided herein are platforms, systems, media, and methods to assign one or more votes of a review one or more vote weights, or use of the same. In some embodiments, a vote weight is determined using a history and/or pattern of reviews from the user providing the vote. In some embodiments, the weight increases when the review pattern and/or the voting pattern of the user providing the vote at least approximately follows a normal distribution. In some embodiments, the weight decreases when the review pattern or the voting pattern of the user providing the vote does not at least approximately follow a normal distribution. In various embodiments, a normal distribution is a Gaussian distribution. In various embodiments, a normal distribution is a bell curve. In various embodiments, alternative statistical distributions are used, for example a lorentzian distribution, a Behrens-Fisher distribution, a Cauchy distribution, a Chernoff's distribution, an Exponentially modified Gaussian distribution, a Fisher-Tippett, a Gumbel distribution, a Fisher's z-distribution a generalized logistic distribution, a generalized normal distribution, a geometric stable distribution, a Holtsmark distribution, a hyperbolic distribution, a hyperbolic secant distribution, a Johnson SU distribution, a Landau distribution, a Laplace distribution, a Lévy skew alpha-stable distribution, a Linnik distribution, a logistic distribution, a map-Airy distribution, a Normal-exponential-gamma distribution, a Normal-inverse Gaussian distribution, a Pearson Distribution, a skew normal distribution, a Student's t-distribution, The non-central t-distribution, a skew t distribution, a type-1 Gumbel distribution, a Tracy-Widom distribution, a Voigt distribution, and/or a Gaussian minus exponential distribution. In some embodiments, the weight decreases when the user providing the review historically provides negative reviews, negative votes, positive reviews, or positive votes. In some embodiments, the weight decreases when the user providing the vote historically provides negative reviews, negative votes, positive reviews, or positive votes on the same or a similar product business or service. In some embodiments, a product is a person. In some embodiments, when the product is a person, the person behaves like a person who is a product. In some embodiments, when the product is a person, the person does not behave like a person who is a product. In some embodiments, the weight decreases when the user providing the vote historically provides negative reviews, negative votes, positive reviews, or positive votes on the same or a similar person.

In some embodiments, provided herein are platforms, systems, media, and methods to assign one or more votes of a review one or more vote weights, or use of the same. In some embodiments, a vote weight is based on a number of votes received by one or more additional reviews submitted by the user providing the vote. In various embodiments, the vote weight increases as the number of votes received by the one or more additional reviews increases. In various embodiments, the vote weight further increases when the one or more additional reviews are to the same or a similar product, business or service. In various embodiments, the vote weight further increases as the weighted review score and/or the total weighted review score of the one or more additional reviews increases. In various embodiments, the vote weight further increases when the user providing the vote previously reviewed the same product, business, or service. In various embodiments, the vote weight decreases when the user providing the vote previously reviewed the same product, business, or service in order to disparage the product, business, or service, respectively. In various embodiments, the vote weight increases when the user providing the vote previously reviewed the same product, business, or service in order to disparage the product, business, or service, respectively. In various embodiments, a similar product is based on the product category. In various embodiments, a similar business is based on the market sector to which the business being reviewed belongs. In various embodiments, a business is similar if it is in the same geographical region as the business being reviewed. In various embodiments, a geographical region is the same neighborhood, zip code, village, town, city, county, state, and/or country. In various embodiments, a similar service is based on the market sector to which the service being reviewed belongs. In various embodiments, a service is similar if it is in the same geographical region as the business being reviewed. In various embodiments, a geographical region is the same neighborhood, zip code, village, town, city, county, state, and/or country. In some embodiments, a product is a person. In some embodiments, when the product is a person, the person behaves like a person who is a product. In some embodiments, when the product is a person, the person does not behave like a person who is a product. In some embodiments, the platforms, systems, media, and methods described herein, are configured to generate a weighted review score of a person.

In some embodiments, provided herein are platforms, systems, media, and methods to assign one or more votes of a review one or more vote weights, or use of the same. In some embodiments, a vote weight is based on a number of votes received by one or more additional reviews submitted by the user providing the vote. In various embodiments, the vote weight increases as the number of votes received by the one or more additional reviews increases. In various embodiments, the vote weight further increases when the one or more additional reviews are to the same or a similar person. In various embodiments, the vote weight further increases as the weighted review score and/or the total weighted review score of the one or more additional reviews increases. In various embodiments, the vote weight further increases when the user providing the vote previously reviewed the same person. In various embodiments, the vote weight decreases when the user providing the vote previously reviewed the same person in order to disparage the person. In various embodiments, the vote weight increases when the user providing the vote previously reviewed the same person in order to disparage the person. In various embodiments, a person is similar if the person is in the same geographical region as the person being reviewed. In various embodiments, a geographical region is the same neighborhood, zip code, village, town, city, county, state, and/or country. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to assign one or more votes of a review one or more vote weights, or use of the same. In some embodiments, a vote weight is based on a length of time a user has been a participant of the review website and/or web service. In various embodiments, the weight increases the longer the user providing the vote has been a participant of the review website and/or web service. In various embodiments, the weight decreases the shorter the user providing the vote has been a participant of the review website and/or web service. In some embodiments, the vote weight is based on a length of time the second user has been voting. In various embodiments, the vote weight increases when the length of time the second user has been voting increases. In various embodiments, the sixth vote weight decreases the shorter the length of time the second user has been voting. In various embodiments, the vote weight increases when the user has been a participant of the website and/or web service or has been voting for greater than about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 25 minutes, about 30 minutes, about 35 minutes, about 40 minutes, about 45 minutes, about 50 minutes about 55 minutes, 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 1 day, about 2 days, about 3 days, about 4 days, about 5 days, about 6 days, about 1 week, about 2 weeks, about 3 weeks, about 1 month, about 2 months, about 3 months, about 4 months, about 5 months, about 6 months, about 7 months, about 8 months, about 9 months, about 10 months, about 11 months, about 1 year, about 2 years, about 3 years, about 4 years, about 5 years, about 6 years, about 7 years, about 8 years, about 9 years, about 10 years, about 15 years, about 20 years, about 25 years, about 30 years, about 35 years, about 40 years, about 45 years, about 50 years, or greater than about 50 years. In various embodiments, the vote weight decreases when the user has been a participant of the website and/or web service or has been voting for less than about 1 minute, less than about 2 minutes, less than about 3 minutes, less than about 4 minutes, less than about 5 minutes, less than about 6 minutes, less than about 7 minutes, less than about 8 minutes, less than about 9 minutes, less than about 10 minutes, less than about 11 minutes, less than about 12 minutes, less than about 13 minutes, less than about 14 minutes, less than about 15 minutes, less than about 16 minutes, less than about 17 minutes, less than about 18 minutes, less than about 19 minutes, less than about 20 minutes, less than about 25 minutes, less than about 30 minutes, less than about 35 minutes, less than about 40 minutes, less than about 45 minutes, less than about 50 minutes less than about 55 minutes, 1 hour, less than about 2 hours, less than about 3 hours, less than about 4 hours, less than about 5 hours, less than about 6 hours, less than about 7 hours, less than about 8 hours, less than about 9 hours, less than about 10 hours, less than about 11 hours, less than about 12 hours, less than about 13 hours, less than about 14 hours, less than about 15 hours, less than about 16 hours, less than about 17 hours, less than about 18 hours, less than about 19 hours, less than about 20 hours, less than about 21 hours, less than about 22 hours, less than about 23 hours, less than about 1 day, less than about 2 days, less than about 3 days, less than about 4 days, less than about 5 days, less than about 6 days, less than about 1 week, less than about 2 weeks, less than about 3 weeks, less than about 1 month, less than about 2 months, less than about 3 months, less than about 4 months, less than about 5 months, less than about 6 months, less than about 7 months, less than about 8 months, less than about 9 months, less than about 10 months, less than about 11 months, less than about 1 year, less than about 2 years, less than about 3 years, less than about 4 years, less than about 5 years, less than about 6 years, less than about 7 years, less than about 8 years, less than about 9 years, less than about 10 years, less than about 15 years, less than about 20 years, less than about 25 years, less than about 30 years, less than about 35 years, less than about 40 years, less than about 45 years, or less than about 50 years.

In some embodiments, provided herein are platforms, systems, media, and methods to assign one or more votes of a review one or more vote weights, or use of the same. In some embodiments, a vote weight is based on a total number of votes submitted by the user providing the vote. In various embodiments, the vote weight increases when the total number of votes submitted by the user providing the vote increases. In various embodiments, the vote weight decreases when the total number of votes submitted by the second user is small. In various embodiments, the total number of votes is submitted by the second user is small when the second user has submitted less than about 1, less than about 2, less than about 3, less than about 4, less than about 5, less than about 6, less than about 7, less than about 8, less than about 9, less than about 10, less than about 15, less than about 20, less than about 25, less than about, 30, less than about 35, less than about 40, less than about 50, less than about 60, less than about 70, less than about 80, less than about 90, less than about 100, less than about 125, less than about 150, less than about 175, less than about 200, less than about 250, less than about 300, less than about 350, less than about 400, less than about 450, less than about 500, less than about 600, less than about 700, less than about 800, less than about 900, less than about 1000, less than about 1250, less than about 1500, less than about 1750, less than about 2000, less than about 2500, less than about 3000, less than about 3500, less than about 4000, less than about 4500, less than about 5000, less than about 6000, less than about 7000, less than about 8000, less than about 9000, less than about 10,000, less than about 12,500, less than about 15,000, less than about 17,500, less than about 20,000, less than about 25,000, less than about 30,000, less than about 35,000, less than about 40,000, less than about 45,000, less than about 50,000, less than about 60,000, less than about 70,000, less than about 80,000, less than about 90,000, less than about 100,000, less than about 125,000, less than about 150,000, less than about 175,000, less than about 200,000, less than about 250,000, less than about 300,000, less than about 350,000, less than about 400,000, less than about 450,000, less than about 500,000, less than about 600,000, less than about 700,000, less than about 800,000, less than about 900,000, or less than about 1,000,000.

In some embodiments, provided herein are platforms, systems, media, and methods to assign one or more votes of a review one or more vote weights, or use of the same. In some embodiments, a vote weight is based on a total number of reviews submitted by the user providing the vote. In various embodiments, the vote weight increases when the total number of reviews submitted by the user providing the vote increases. In various embodiments, the vote weight decreases when the total number of reviews submitted by the second user is small.

In some embodiments, provided herein are platforms, systems, media, and methods to assign one or more votes of a review one or more vote weights, or use of the same. In some embodiments, a vote weight is based on a percentage of the total number of votes submitted by the user to the same or a similar product, business, and/or service. In various embodiments, the vote weight increases when the percentage of votes to the same or a similar product, business, and/or service increases. In various embodiments, the vote weight is larger when the percentage of votes to the same or a similar product, business, and/or service is larger. In various embodiments, the vote weight decreases when the percentage of votes to the same or a similar product, business, and/or service decreases. In various embodiments, the vote weight is smaller when the percentage of votes to the same or a similar product, business, and/or service is smaller. In some embodiments, a user who has submitted an overall fewer number of votes but has a higher percentage of votes and/or reviews to the same or a similar product, business, or service has a higher vote weight compared to another user who has submitted an overall higher number of votes. In some embodiments, a user who has submitted an overall greater number of votes and has a higher percentage of votes and/or reviews to the same or a similar product, business, or service, has a higher vote weight compared to another user who has a lower percentage of reviews to the same or a similar product, business, and/or service. In some embodiments, a user who has submitted a higher percentage of votes and/or reviews to the same or a similar product, business, or service has a higher vote weight compared to another user who has a lower percentage of reviews to the same or a similar product, business, and/or service. In some embodiments, a product is a person. In some embodiments, when the product is a person, the person behaves like a person who is a product. In some embodiments, when the product is a person, the person does not behave like a person who is a product.

In some embodiments, provided herein are platforms, systems, media, and methods to assign one or more votes of a review one or more vote weights, or use of the same. In some embodiments, a vote weight is based on a percentage of the total number of votes submitted by the user to the same or a similar person. In various embodiments, the vote weight increases when the percentage of votes to the same or a similar person increases. In various embodiments, the vote weight is larger when the percentage of votes to the same or a similar person is larger. In various embodiments, the vote weight decreases when the percentage of votes to the same or a similar person decreases. In various embodiments, the vote weight is smaller when the percentage of votes to the same or a similar person is smaller. In some embodiments, a user who has submitted an overall fewer number of votes but has a higher percentage of votes and/or reviews to the same or a similar person has a higher vote weight compared to another user who has submitted an overall higher number of votes. In some embodiments, a user who has submitted an overall greater number of votes and has a higher percentage of votes and/or reviews to the same or a similar person, has a higher vote weight compared to another user who has a lower percentage of reviews to the same or a similar person. In some embodiments, a user who has submitted a higher percentage of votes and/or reviews to the same or a similar person has a higher vote weight compared to another user who has a lower percentage of reviews to the same or a similar person. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to assign one or more votes of a review one or more vote weights, or use of the same. In some embodiments, the vote weight is based on the frequency in which a user has reviewed the same or a similar product, business, and/or service. In various embodiments, the higher the frequency of reviewing and/or voting on the same or a similar product, business, and/or service, the higher the vote weight. In various embodiments, the lower the frequency of reviewing and/or voting on the same or a similar product, business, and/or service, the lower the vote weight. In various embodiments, a user who has submitted an overall fewer number of votes but who has more frequently reviewed and/or voted on the same or a similar product, business, and/or service has a higher vote weight than another user who has less frequently reviewed and/or voted on the same or a similar product, business, and/or service. In various embodiments, a user who has submitted an overall greater number of votes and who has more frequently reviewed and/or voted on the same or a similar product, business, and/or service has a higher vote weight than another user who has less frequently reviewed and/or voted on the same or a similar product, business, and/or service. In various embodiments, a user who has more frequently reviewed and/or voted on the same or a similar product, business, and/or service has a higher vote weight than another user who has less frequently reviewed and/or voted on the same or a similar product, business, and/or service.

In some embodiments, provided herein are platforms, systems, media, and methods to assign one or more votes of a review one or more vote weights, or use of the same. In some embodiments, the vote weight is based on the frequency in which a user has reviewed the same or a similar person. In various embodiments, the higher the frequency of reviewing and/or voting on the same or a similar person, the higher the vote weight. In various embodiments, the lower the frequency of reviewing and/or voting on the same or a similar person, the lower the vote weight. In various embodiments, a user who has submitted an overall fewer number of votes but who has more frequently reviewed and/or voted on the same or a similar person has a higher vote weight than another user who has less frequently reviewed and/or voted on the same or a similar person. In various embodiments, a user who has submitted an overall greater number of votes and who has more frequently reviewed and/or voted on the same or a similar person has a higher vote weight than another user who has less frequently reviewed and/or voted on the same or a similar person. In various embodiments, a user who has more frequently reviewed and/or voted on the same or a similar person has a higher vote weight than another user who has less frequently reviewed and/or voted on the same or a similar person. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to assign one or more votes of a review one or more vote weights, or use of the same. In some embodiments, vote weights are assigned based on one or more relationships and/or endorsements. As a non-limiting example, when a user and/or a review submitted by a user is endorsed (i.e., voted in favor of) by a more “trusted” user, some or all of that “trust” is passed along to the user and/or the review. In some embodiments, “trust” is also described as influence, credence, credit, confidence, clout, effect, prestige, significance, and/or weight. In some embodiments, a vote is an, opinion, emotion, and/or endorsement.

In some embodiments, provided herein are platforms, systems, media, and methods to assign one or more votes of a review one or more vote weights, or use of the same. In some embodiments, vote weights are assigned based on one or more relationships and/or endorsements. As a non-limiting example, when a user and/or a review submitted by a user is endorsed (i.e., voted in favor of) by a more “trusted” user, some or all of that “trust” is passed along to the user and/or the review. In some embodiments, “trust” is also described as influence, credence, credit, confidence, clout, effect, prestige, significance, and/or weight. In some embodiments, a vote is an opinion, emotion, and/or endorsement. In some embodiments, a user becomes more trusted when the user submits reviews and/or votes for a long period of time. In various embodiments, a long period of time is about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 25 minutes, about 30 minutes, about 35 minutes, about 40 minutes, about 45 minutes, about 50 minutes about 55 minutes, 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 1 day, about 2 days, about 3 days, about 4 days, about 5 days, about 6 days, about 1 week, about 2 weeks, about 3 weeks, about 1 month, about 2 months, about 3 months, about 4 months, about 5 months, about 6 months, about 7 months, about 8 months, about 9 months, about 10 months, about 11 months, about 1 year, about 2 years, about 3 years, about 4 years, about 5 years, about 6 years, about 7 years, about 8 years, about 9 years, about 10 years, about 15 years, about 20 years, about 25 years, about 30 years, about 35 years, about 40 years, about 45 years, about 50 years, or greater than about 50 years. In various embodiments, the user submits reviews relatively regularly within the long period of time. As a non-limiting example, in some embodiments, a user submits votes, about daily, about weekly, about bi-weekly, about monthly, about bi-monthly, about every six months, about every year, or about every two years. In various embodiments, a user becomes more trusted the longer the user submits reviews and/or votes.

In some embodiments, provided herein are platforms, systems, media, and methods to assign one or more votes of a review one or more vote weights, or use of the same. In some embodiments, vote weights are assigned based on one or more relationships and/or endorsements. As a non-limiting example, when a user and/or a review submitted by a user is endorsed (i.e., voted in favor of) by a more “trusted” user, some or all of that “trust” is passed along to the user and/or the review. In some embodiments, “trust” is also described as influence, credence, credit, confidence, clout, effect, prestige, significance, and/or weight. In some embodiments, a vote is an, opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user. In various embodiments, a user becomes more trusted when the user has a review and/or a voting pattern that at least approximately follows a normal distribution. In various embodiments, a normal distribution is a Gaussian distribution. In various embodiments, a normal distribution is a bell curve. In various embodiments, alternative statistical distributions are used, for example a lorentzian distribution, a Behrens-Fisher distribution, a Cauchy distribution, a Chernoffs distribution, an Exponentially modified Gaussian distribution, a Fisher-Tippett, a Gumbel distribution, a Fisher's z-distribution a generalized logistic distribution, a generalized normal distribution, a geometric stable distribution, a Holtsmark distribution, a hyperbolic distribution, a hyperbolic secant distribution, a Johnson SU distribution, a Landau distribution, a Laplace distribution, a Lévy skew alpha-stable distribution, a Linnik distribution, a logistic distribution, a map-Airy distribution, a Normal-exponential-gamma distribution, a Normal-inverse Gaussian distribution, a Pearson Distribution, a skew normal distribution, a Student's t-distribution, The non-central t-distribution, a skew t distribution, a type-1 Gumbel distribution, a Tracy-Widom distribution, a Voigt distribution, and/or a Gaussian minus exponential distribution. In some embodiments, the amount of trust gained by a user decreases when the user historically provides negative reviews, negative votes, positive reviews, or positive votes. In some embodiments, the amount of trust gained by a user decreases when the user historically provides negative reviews, negative votes, positive reviews, or positive votes on the same or a similar product, business, or service, because, for example the user reviews do not provide adequate differentiation. In some embodiments, the amount of trust gained by a user decreases when the user historically provides neutral reviews on the same or a similar product, business, or service, because, for example the user reviews do not provide adequate differentiation. In some embodiments, a product is a person. In some embodiments, when the product is a person, the person behaves like a person who is a product. In some embodiments, when the product is a person, the person does not behave like a person who is a product. In some embodiments, the amount of trust gained by a user decreases when the user historically provides negative reviews, negative votes, positive reviews, or positive votes on the same or a similar person, because, for example the user reviews do not provide adequate differentiation. In some embodiments, the amount of trust gained by a user decreases when the user historically provides neutral reviews on the same or a similar person, because, for example the user reviews do not provide adequate differentiation.

In some embodiments, provided herein are platforms, systems, media, and methods to assign one or more votes of a review one or more vote weights, or use of the same. In some embodiments, vote weights are assigned based on one or more relationships and/or endorsements. As a non-limiting example, when a user and/or a review submitted by a user is endorsed (i.e., voted in favor of) by a more “trusted” user, some or all of that “trust” is passed along to the user and/or the review. In some embodiments, “trust” is also described as influence, credence, credit, confidence, clout, effect, prestige, significance, and/or weight. In some embodiments, a vote is an, opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user. In some embodiments, a user becomes more trusted when the user previously reviewed the same and/or a similar product, business, or service. In various embodiments, a user becomes more trusted when the user previously reviewed the same product, business, or service. In various embodiments, a similar product is based on the product category. In various embodiments, a similar business is based on the market sector to which the business being reviewed belongs. In various embodiments, a business is similar if it is in the same geographical region as the business being reviewed. In various embodiments, a geographical region is the same neighborhood, zip code, village, town, city, county, state, and/or country. In various embodiments, a similar service is based on the market sector to which the service being reviewed belongs. In various embodiments, a service is similar if it is in the same geographical region as the business being reviewed. In various embodiments, a geographical region is the same neighborhood, zip code, village, town, city, county, state, and/or country. In some embodiments, a product is a person. In some embodiments, when the product is a person, the person behaves like a person who is a product. In some embodiments, when the product is a person, the person does not behave like a person who is a product.

In some embodiments, provided herein are platforms, systems, media, and methods to assign one or more votes of a review one or more vote weights, or use of the same. In some embodiments, vote weights are assigned based on one or more relationships and/or endorsements. As a non-limiting example, when a user and/or a review submitted by a user is endorsed (i.e., voted in favor of) by a more “trusted” user, some or all of that “trust” is passed along to the user and/or the review. In some embodiments, “trust” is also described as influence, credence, credit, confidence, clout, effect, prestige, significance, and/or weight. In some embodiments, a vote is an, opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user. In some embodiments, a user becomes more trusted when the user previously received a large number of votes on one or more reviews submitted by the user. In various embodiments, a user becomes more trusted as the number of votes received by the one or more reviews increases. In various embodiments, a user becomes more trusted when the one or more reviews are to the same or a similar product, business or service. In various embodiments, a user becomes more trusted as the weighted review score and/or the total weighted review score of the one or more reviews increases. In various embodiments, a similar product is based on the product category. In various embodiments, a similar business is based on the market sector to which the business being reviewed belongs. In various embodiments, a business is similar if it is in the same geographical region as the business being reviewed. In various embodiments, a geographical region is the same neighborhood, zip code, village, town, city, county, state, and/or country. In various embodiments, a similar service is based on the market sector to which the service being reviewed belongs. In various embodiments, a service is similar if it is in the same geographical region as the business being reviewed. In various embodiments, a geographical region is the same neighborhood, zip code, village, town, city, county, state, and/or country.

In some embodiments, provided herein are platforms, systems, media, and methods to assign one or more votes of a review one or more vote weights, or use of the same. In some embodiments, vote weights are assigned based on one or more relationships and/or endorsements. As a non-limiting example, when a user and/or a review submitted by a user is endorsed (i.e., voted in favor of) by a more “trusted” user, some or all of that “trust” is passed along to the user and/or the review. In some embodiments, “trust” is also described as influence, credence, credit, confidence, clout, effect, prestige, significance, and/or weight. In some embodiments, a vote is an, opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user. In various embodiments, a user becomes more trusted as the number of votes received by the one or more reviews increases. In some embodiments, a user becomes more trusted when the user previously reviewed the same and/or a similar person. In various embodiments, a user becomes more trusted when the user previously reviewed the same person. In various embodiments, a user becomes more trusted as the number of votes received by the one or more reviews increases. In various embodiments, a user becomes more trusted as the weighted review score and/or the total weighted review score of the one or more reviews increases. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to assign one or more votes of a review one or more vote weights, or use of the same. In some embodiments, vote weights are assigned based on one or more relationships and/or endorsements. As a non-limiting example, when a user and/or a review submitted by a user is endorsed (i.e., voted in favor of) by a more “trusted” user, some or all of that “trust” is passed along to the user and/or the review. In some embodiments, “trust” is also described as influence, credence, credit, confidence, clout, effect, prestige, significance, and/or weight. In some embodiments, a vote is an, opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user. In some embodiments, a user becomes more trusted when the user has recently submitted a review and/or a vote. In various embodiments, a review and/or vote is recently submitted when the review and/or vote was submitted within about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 25 minutes, about 30 minutes, about 35 minutes, about 40 minutes, about 45 minutes, about 50 minutes about 55 minutes, 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours, about 2 days, about 3 days, about 4 days about 5 days, about 6 days, about 1 week, about 2 weeks, about 3 weeks, about 1 month, about 2 months, about 3 months, about 4 months, about 5 months, about 6 months, about 7 months, about 8 months, about 9 months, about 10 months, about 11 months, about 1 year, about 2 years, about 3 years, about 4 years, about 5 years, about 6 years, about 7 years, about 8 years, about 9 years, about 10 years, about 15 years, about 20 years, about 25 years, about 30 years, about 35 years, about 40 years, about 45 years, or about 50 years. In some embodiments, a user becomes more trusted when the user recently submitted a review and/or vote on the same and/or a similar product, business, or service. In various embodiments, a user becomes more trusted when the user recently submitted a review and/or vote on the same product, business, or service. In various embodiments, a similar product is based on the product category. In various embodiments, a similar business is based on the market sector to which the business being reviewed belongs. In various embodiments, a business is similar if it is in the same geographical region as the business being reviewed. In various embodiments, a geographical region is the same neighborhood, zip code, village, town, city, county, state, and/or country. In various embodiments, a similar service is based on the market sector to which the service being reviewed belongs. In various embodiments, a service is similar if it is in the same geographical region as the business being reviewed. In various embodiments, a geographical region is the same neighborhood, zip code, village, town, city, county, state, and/or country.

In some embodiments, provided herein are platforms, systems, media, and methods to assign one or more votes of a review one or more vote weights, or use of the same. In some embodiments, vote weights are assigned based on one or more relationships and/or endorsements. As a non-limiting example, when a user and/or a review submitted by a user is endorsed (i.e., voted in favor of) by a more “trusted” user, some or all of that “trust” is passed along to the user and/or the review. In some embodiments, “trust” is also described as influence, credence, credit, confidence, clout, effect, prestige, significance, and/or weight. In some embodiments, a vote is an, opinion, an emotion, and/or an endorsement. In some embodiments, a vote is in response to a review submitted by another user. In some embodiments, a vote is based on the user who provided the review. In some embodiments, a vote is in favor of a user and/or a review submitted by the user. In some embodiments, a vote is not in favor of a user and/or a review submitted by the user. In some embodiments, a user becomes more trusted when the user has recently submitted a review and/or a vote. In various embodiments, a review and/or vote is recently submitted when the review and/or vote was submitted within about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 25 minutes, about 30 minutes, about 35 minutes, about 40 minutes, about 45 minutes, about 50 minutes about 55 minutes, 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours, about 2 days, about 3 days, about 4 days about 5 days, about 6 days, about 1 week, about 2 weeks, about 3 weeks, about 1 month, about 2 months, about 3 months, about 4 months, about 5 months, about 6 months, about 7 months, about 8 months, about 9 months, about 10 months, about 11 months, about 1 year, about 2 years, about 3 years, about 4 years, about 5 years, about 6 years, about 7 years, about 8 years, about 9 years, about 10 years, about 15 years, about 20 years, about 25 years, about 30 years, about 35 years, about 40 years, about 45 years, or about 50 years. In some embodiments, a user becomes more trusted when the user recently submitted a review and/or vote on the same and/or a similar person. In various embodiments, a user becomes more trusted when the user recently submitted a review and/or vote on the person. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to assign one or more votes of a review one or more vote weights, or use of the same. In some embodiments, vote weights are assigned based on one or more relationships and/or endorsements. In some embodiments, one or more vote weights are assigned based on whether the user providing the vote is in a measured relationship. In further or additional embodiments, a user in a measured relationship indicates the user currently performs an act and/or is in a measureable situation. As a non-limiting example, a currently performed act and/or a measurable situation comprises working at a business, attending a school/college/university, dating another person, being a friend of another person, being an acquaintance of another person, being a relative of another person, making a revolving purchase, being in a contract, currently being on vacation, currently attending a sporting event, currently attending a play, currently attending a musical, currently attending an opera, and currently attending a movie. Those of skill in the art will recognize the aforementioned list of non-limiting examples includes other currently performed acts and/or measurable situations not literally described herein. In further or additional embodiments, a user who will be in a measured relationship indicates the user will perform a future act or will be in a measurable situation. As a non-limiting example, the future act comprises taking a future vacation, being in a future contract, attending a future class in a school/college/university, going on a future date with another person, commencing employment at a business, attending a sporting event, attending a play, attending a musical, attending an opera, and attending a movie. Those of skill in the art will recognize the aforementioned list of non-limiting examples includes other future acts and/or measureable situations not literally described herein. In further or additional embodiments, a user who was in a measured relationship indicates the user previously performed an act or was in a measurable situation. As a non-limiting example, the performed act comprises previously taking a vacation, previously being in a contract, previously attending a class in a school/college/university, previously dating another person, previously being a friend of another person, previously being an acquaintance of another person, previously being a relative of another person, previously being employed at a business, previously attending a sporting event, previously attending a play, previously attending a musical, previously attending an opera, and previously attending a movie. Those of skill in the art will recognize the aforementioned list of non-limiting examples includes other previous acts and/or measureable situations not literally described herein.

In some embodiments, provided herein are platforms, systems, media, and methods to assign one or more votes of a review one or more vote weights, or use of the same. In some embodiments, vote weights are assigned based on one or more relationships and/or endorsements. In some embodiments, one or more vote weights are assigned based on whether the user providing the vote is in a measured relationship. In various embodiments, a vote weight increases when a user votes on a review and the content of the review is related to the measured relationship in which the user is involved. In further or additional embodiments, the more closely related the measured relationship is to the content of the review, the more the vote weight increases. In further or additional embodiments, the less closely related the measured relationship is to the content of the review, the less the vote weight increases. In various embodiments, a vote weight increases when a user votes on a review and the content of the review is related to the measured relationship in which will be involved. In further or additional embodiments, the more closely related the measured relationship is to the content of the review, the more the vote weight increases. In further or additional embodiments, the less closely related the measured relationship is to the content of the review, the less the vote weight increases. In further or additional embodiments, the vote weight increases the shorter the time period between the vote and when the user will be in the measured relationship. In various embodiments, a vote weight increases when a user votes on a review and the content of the review is related to the measured relationship in which the user was involved. In further or additional embodiments, the more closely related the measured relationship is to the content of the review, the more the vote weight increases. In further or additional embodiments, the less closely related the measured relationship is to the content of the review, the less the vote weight increases. In further or additional embodiments, the vote weight increases the shorter the time period between the vote and when the user was in the measured relationship.

In some embodiments, provided herein are platforms, systems, media, and methods to assign one or more votes of a review one or more vote weights, or use of the same. In some embodiments, a vote weight is based on whether a user is a verified user. In various embodiments, a vote weight increases when the user providing the review and/or vote is a verified user. In various embodiments, a user is verified when the user confirms he/she have previously purchased the product, used the product, visited the business, and/or used the service. In various embodiments, confirming purchase of the product comprises photographing a receipt of purchase, submitting a receipt of purchase, photographing a UPC of the purchased product, and submitting a UPC of the purchased product. In various embodiments, confirming the user visited the business comprises submitting a photograph of the business with or without the user present, submitting verification via GPS that the user visited the business, and/or granting access to an application on a user's wireless device to access the location of the user which shows the user visited the business. In various embodiments, confirming the user used the service comprises photographing a receipt of purchase, submitting a receipt of purchase, and/or having the service provider confirm the user used the service. In some embodiments, a business verifies a person or another entity is a customer of the business.

In some embodiments, provided herein are platforms, systems, media, and methods to assign one or more votes of a review one or more vote weights, or use of the same. In some embodiments, a vote weight is based on whether a user is a verified user. In various embodiments, a vote weight increases when the user providing the review and/or vote is a verified user. In various embodiments, a user is verified when the user confirms he/she have previously purchased the product, used the product, visited the business, and/or used the service. In various embodiments the more trustworthy a user the more likely the person will be able to self-validate he/she previously purchased the product, used the product, visited the business, and/or used the service. In various embodiments, a less trustworthy user will require additional verification methods to ensure the user purchased the product, used the product, visited the business, and/or used the service.

In some embodiments, provided herein are platforms, systems, media, and methods to assign one or more votes of a review one or more vote weights, or use of the same. In some embodiments, a vote weight is based on whether a user is a verified user. In various embodiments, the verified user is in a measured relationship, was in a measured relationship, or will be in a measured relationship. In various embodiments, a person is in a measured relationship when the person is verified to work at a business. In various embodiments, a person verifies himself/herself works at a business. In further or additional embodiments, a person is verified to work at a business when a current and/or former co-worker verifies the person works at the business. In various embodiments, a person was in a measured relationship when the person is verified to have previously worked at a business. In various embodiments, a person verifies himself/herself worked at a business. In further or additional embodiments, a person is verified to have previously worked at a business when a current and/or former co-worker verifies the person previously worked at the business. In various embodiments, a person will be in a measured relationship when the person is verified to soon be working at a business. In various embodiments, a person verifies himself/herself will soon be working at a business. In further or additional embodiments, a person is verified to soon be working at a business when a future co-worker verifies the person previously will be working at the business.

In some embodiments, provided herein are platforms, systems, media, and methods to assign one or more votes of a review one or more vote weights, or use of the same. In some embodiments, a vote weight is based on whether a user is a verified user. In various embodiments, the verified user is in a measured relationship, was in a measured relationship, or will be in a measured relationship. In various embodiments, a person is in a measured relationship when the person is verified to be a current student of an institution, for example a school/college/university. In various embodiments, a person verifies himself/herself is a student of an institution, for example a school/college/university. In further or additional embodiments, a person is verified to be a current student of an institution, for example a school/college/university, when the institution verifies the person currently attends the school/college/university. In further or additional embodiments, a person is verified to be a current student of an instructor/professor when the instructor/professor verifies the person currently in the instructor's/professor's class. In further or additional embodiments, a current or former classmate verifies a person currently attends an institution, for example a school/college/university. In various embodiments, a current or former classmate verifies a person is a current student of an instructor/professor. In various embodiments, a person was in a measured relationship when the person is verified to be a former student of an institution, for example a school/college/university. In various embodiments, a person verifies himself/herself was a student of an institution, for example a school/college/university. In further or additional embodiments, a person is verified to be a former student of an institution, for example a school/college/university, when the institution verifies the person attended the school/college/university. In further or additional embodiments, a person is verified to be a former student of an instructor/professor when the instructor/professor verifies the person was formerly in the instructor's/professor's class. In further or additional embodiments, a current or former classmate verifies a person attended an institution, for example a school/college/university. In various embodiments, a current or former classmate verifies a person is a former student of an instructor/professor. In various embodiments, a person will be in a measured relationship when the person is verified to be a future student of an institution, for example a school/college/university. In various embodiments, a person verifies himself/herself will be a student of an institution, for example a school/college/university. In further or additional embodiments, a person is verified to be a future student of an institution, for example a school/college/university, when the institution verifies the person will attend the school/college/university. In further or additional embodiments, a person is verified to be a future student of an instructor/professor when the instructor/professor verifies the person will be in the instructor's/professor's class. In further or additional embodiments, a future classmate verifies a person will attend an institution, for example a school/college/university. In various embodiments, a future classmate verifies a person will be a student of an instructor/professor.

In some embodiments, provided herein are platforms, systems, media, and methods to assign one or more votes of a review one or more vote weights, or use of the same. In some embodiments, a vote weight is based on whether a user is a verified user. In various embodiments, the verified user is in a measured relationship, was in a measured relationship, or will be in a measured relationship. In various embodiments, a person is in a measured relationship when the person is verified to be dating another person. In various embodiments, a person verifies himself/herself is dating another person. In further or additional embodiments, a first person is verified to be dating a second person when the second person confirms he/she dated the first person. In further or additional embodiments, a first person is verified to dating a second person when a third person verifies the first and second person are dating. In various embodiments, a person was in a measured relationship when the person is verified to have previously dated another person. In various embodiments, a person verifies himself/herself previously dated another person. In further or additional embodiments, a first person is verified to have dated a second person when the second person confirms he/she dated the first person. In further or additional embodiments, a first person is verified to have dated a second person when a third person verifies the first and second person dated. In various embodiments, a person will be in a measured relationship when the person is verified to soon be dating another person. In various embodiments, a person verifies himself/herself will soon be dating another person. In further or additional embodiments, a first person is verified to soon be dating a second person when the second person confirms he/she will soon be dating first person. In further or additional embodiments, a first person is verified to soon be dating a second person when a third person verifies the first and second person will soon be dating.

In some embodiments, provided herein are platforms, systems, media, and methods to assign one or more votes of a review one or more vote weights, or use of the same. In some embodiments, a vote weight is based on whether a user is a verified user. In various embodiments, the verified user is in a measured relationship, was in a measured relationship, or will be in a measured relationship. In various embodiments, a person is in a measured relationship when the person is verified to be a friend of another person. In various embodiments, a person verifies himself/herself is a friend of another person. In further or additional embodiments, a first person is verified to be a friend of a second person when the second person confirms he/she is a friend of the first person. In further or additional embodiments, a first person is verified to be a friend of a second person when a third person verifies the first and second person are friends. In various embodiments, a person was in a measured relationship when the person is verified to have previously been a friend of another person. In various embodiments, a person verifies himself/herself was a friend of another person. In further or additional embodiments, a first person is verified to have been a friend of a second person when the second person confirms he/she was a friend of the first person. In further or additional embodiments, a first person is verified to have been a friend of a second person when a third person verifies the first and second were friends. In various embodiments, a person will be in a measured relationship when the person is verified to soon be a friend of another person. In various embodiments, a person verifies himself/herself will be a friend of another person. In further or additional embodiments, a first person is verified to soon be a friend of a second person when the second person confirms he/she will soon be a friend of the first person. In further or additional embodiments, a first person is verified to soon be a friend of a second person when a third person verifies the first and second person will soon be friends. In some embodiments, a friend is an acquaintance. In some embodiments, being a friend is being an acquaintance. In some embodiments, a friend and/or acquaintance is a person with whom another person has interacted. In various embodiments, interacting with a person comprises at least one of seeing a person, talking to a person, meeting a person, and shaking hands with a person. In various embodiments, a friend and/or acquaintance is another user of the internet and/or another network. In various embodiments, a friend and/or acquaintance is another user of an internet and/or network service with whom a user has or has not interacted physically. In various embodiments, a friend and/or acquaintance is another user of an internet and/or network service with whom a user has or has not interacted over the internet and/or network, respectively. As a non-limiting example, an internet and/or network service comprises a social networking service, a social media service, a chat service, a mobile communication service. As a non-limiting example, an internet and/or network service comprises Facebook, Twitter, Tumblr, Pinterest, Snapchat, a text message service, a dating service, and any service and/or application where two users can interact over the internet and/or another network.

In some embodiments, provided herein are platforms, systems, media, and methods to assign one or more votes of a review one or more vote weights, or use of the same. In some embodiments, a vote weight is based on whether a user is a verified user. In various embodiments, the verified user is in a measured relationship, was in a measured relationship, or will be in a measured relationship. In various embodiments, a person is in a measured relationship when the person is verified to be a relative of another person. In various embodiments, a person verifies himself/herself is a relative of another person. In further or additional embodiments, a first person is verified to be a relative of a second person when the second person confirms he/she is a relative of the first person. In further or additional embodiments, a first person is verified to be a relative of a second person when a third person verifies the first and second person are relatives. In various embodiments, a person was in a measured relationship when the person is verified to have previously been a relative of another person. In various embodiments, a person verifies himself/herself was a relative of another person. In further or additional embodiments, a first person is verified to have been a relative of a second person when the second person confirms he/she was a relative of the first person. In further or additional embodiments, a first person is verified to have been a relative of a second person when a third person verifies the first and second person were relatives. In various embodiments, a person will be in a measured relationship when the person is verified to soon be a relative of another person. In various embodiments, a person verifies himself/herself will be a relative of another person. In further or additional embodiments, a first person is verified to soon be a relative of a second person when the second person confirms he/she will soon be a relative of first person. In further or additional embodiments, a first person is verified to soon be a relative of a second person when a third person verifies the first and second person will soon be relatives.

In some embodiments, provided herein are platforms, systems, media, and methods to assign one or more votes of a review one or more vote weights, or use of the same. In some embodiments, a vote weight is based on whether a user is a verified user. In various embodiments, the verified user is in a measured relationship, was in a measured relationship, or will be in a measured relationship. In some embodiments, a person is in a measured relationship when the person is connected to another person by one or more degrees of separation. As a non-limiting example, one or more degrees of separation comprises a friend of a friend, a former girlfriend/boyfriend of a friend, a former professor of another person, a former professor of a friend of a friend, a former girlfriend/boyfriend of a friend of a friend, a friend who is a former employee of a business/organization. All degrees of separation connecting one or more persons not explicitly stated are incorporated herein. In some embodiments, a user who is in a measured relationship when the person is connected to another person by one or more degrees of separation bases his/her review, vote, opinion, emotion, and/or endorsement based on comments and/or experiences of the another person. As a non-limiting example, a user who is a friend of another person who previously had a professor provides a review, vote, opinion, emotion and/or endorsement of the professor based on comments/experiences of the friend who had the professor. As an additional non-limiting example, a user who is a friend of another person who previously had a girlfriend/boyfriend provides a review, vote, opinion, emotion and/or endorsement of the girlfriend/boyfriend based on comments/experiences of the friend who previously had the girlfriend/boyfriend. In some embodiments the greater the degree of separation between persons the lower the weight associated with the vote, opinion, emotion and/or endorsement.

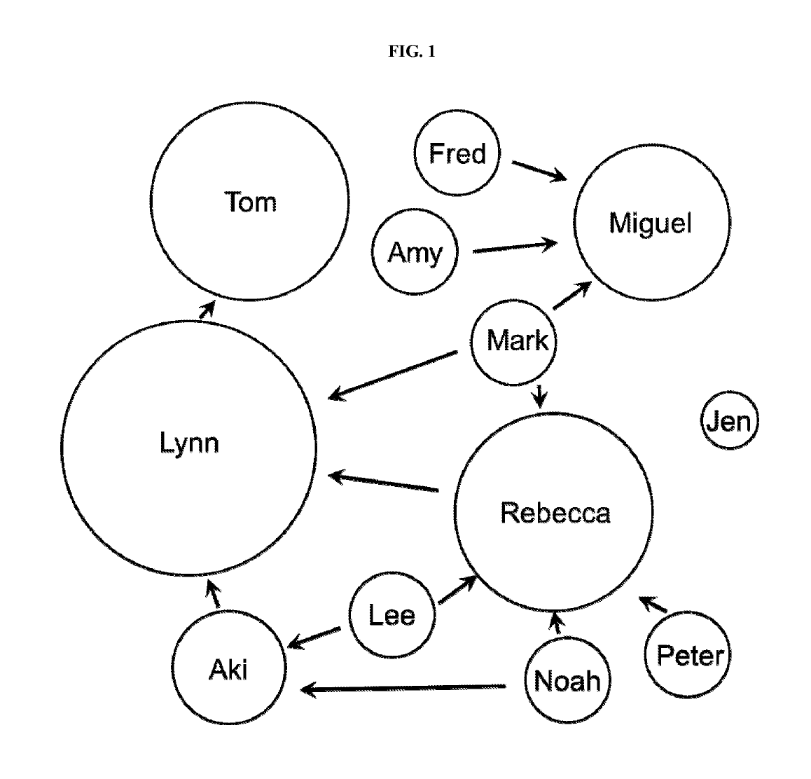

In some embodiments, provided herein are platforms, systems, media, and methods to assign one or more votes of a review one or more vote weights, or use of the same. In some embodiments, when a user and/or a review submitted by a user is endorsed (e.g., voted in favor of) by a more “trusted” user, some or all of that “trust” is passed along to the user and/or the review. In some embodiments, influence and/or trust is calculated using a linear scale, a logarithmic scale, or a combination thereof. In some embodiments, one or more additional mathematical functions are used to calculate influence and/or trust, for example an exponential and/or a polynomial function. Thus, in some embodiments, a scaled amount of “trust” is passed along to another user, for example a logarithmically scaled amount of “trust.” In some embodiments, a user who has not yet participated by submitting a review and/or voting/endorsing another user and/or review has gained little trust. In some embodiments, users who have participated by submitting a review and/or voting/endorsing another user and/or review gain trust. In some embodiments, a user or a user's review that has received votes/endorsements/positive opinions/positive emotions from one or more other users gains trust. In some embodiments, a user who has received a fewer number of votes/endorsements/positive opinions/positive emotions but has previously reviewed the same or a similar product, business, and/or service has more trust for the particular product, business, and/or service compared to another user who has not previously reviewed the same or a similar product, business, and/or service. In some embodiments, a user who has received more votes, opinions, emotions, and/or endorsements on a review to the same or a similar product, business, or service has more trust than another user who has received a fewer number of votes, opinions, emotions, and/or endorsements on a review to the same or a similar product, business, and/or service. In some embodiments, a user who has received more votes, opinions, emotions, and/or endorsements on a review to the same or a similar product, business, or service has more trust with respect to the same or similar product, business, or service than another user who has overall more trust but has received a fewer number of votes, opinions, emotions, and/or endorsements on a review to the same or a similar product, business, and/or service. In some embodiments, a user and/or a review submitted by the user receives a votes/endorsements/positive opinions/positive emotions from a highly trusted user, receives some or all of the trust of the trusted user. A non-limiting example of the platforms, systems, methods and media described herein is depicted in FIG. 1 and Example 1.

In some embodiments, provided herein are platforms, systems, media, and methods to assign one or more votes of a review one or more vote weights, or use of the same. In some embodiments, when a user and/or a review submitted by a user is endorsed (e.g., voted in favor of) by a more “trusted” user, some or all of that “trust” is passed along to the user and/or the review. In some embodiments, influence and/or trust is calculated using a linear scale, a logarithmic scale, or a combination thereof. In some embodiments, one or more additional mathematical functions are used to calculate influence and/or trust, for example an exponential and/or a polynomial function. Thus, in some embodiments, a scaled amount of “trust” is passed along to another user, for example a logarithmically scaled amount of “trust.” In some embodiments, a user who has not yet participated by submitting a review and/or voting/endorsing another user and/or review has gained little trust. In some embodiments, users who have participated by submitting a review and/or voting/endorsing another user and/or review gain trust. In some embodiments, a user or a user's review that has received votes/endorsements/positive opinions/positive emotions from one or more other users gains trust. In some embodiments, a user who has received a fewer number of votes/endorsements/positive opinions/positive emotions but has previously reviewed the same or a similar person has more trust compared to another user who has not previously reviewed the same or a similar person. In some embodiments, a user who has received more votes, opinions, emotions, and/or endorsements on a review to the same or a similar person has more trust than another user who has received a fewer number of votes, opinions, emotions, and/or endorsements on a review to the same or a similar person. In some embodiments, a user who has received more votes, opinions, emotions, and/or endorsements on a review to the same or a similar person has more trust with respect to the same or similar person than another user who has overall more trust but has received a fewer number of votes, opinions, emotions, and/or endorsements on a review to the same or a similar person. In some embodiments, a user and/or a review submitted by the user receives a votes/endorsements/positive opinions/positive emotions from a highly trusted user, receives some or all of the trust of the trusted user. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to assign one or more votes of a review one or more vote weights, or use of the same. In some embodiments, one or more vote weights are modified and/or scaled using a mathematical function, for example a linear function, a logarithmic function, an exponential function, a polynomial function, or a combination thereof. Those of skill in the art will recognize the aforementioned list of mathematical functions includes other mathematical not literally described herein.

In some embodiments, provided herein are platforms, systems, media, and methods to assign one or more votes of a review one or more vote weights, or use of the same. In some embodiments, endorsements, opinions, emotions, and/or votes by certain users result in negative weights being assigned to the review to which the endorsement, opinion, emotion, and/or vote is targeted. In some embodiments, the certain users are troublesome users. In various embodiments a troublesome user is a troll. In various embodiments a troublesome user is a flamer. In various embodiments, a troublesome user is one who is intentionally endorsing and/or voting and/or reviewing to spite the product, business or service. In various embodiments, a troublesome user is one who is intentionally endorsing and/or voting and/or reviewing to spite the person. As a non-limiting example, when a troublesome user endorses another user and/or review, a negative weighted review score is assigned to the user and/or the review.

In some embodiments, provided herein are platforms, systems, media, and methods to assign one or more votes of a review one or more vote weights, or use of the same. In some embodiments, endorsements, opinions, emotions, and/or votes by certain users result in zero/neutral weights being assigned to the review to which the endorsement, opinion, emotion, and/or vote is targeted. In various embodiments, the certain users are new users. In various embodiments, the certain users are users who have not gained “trust.”

In some embodiments, provided herein are platforms, systems, media, and methods to assign one or more votes of a review one or more vote weights, or use of the same. In some embodiments, the trust garnered by a user for a particular product, business, or service diminishes based on time and/or other factors. As a non-limiting example, as depicted in FIG. 1, if Miguel's three vegan restaurant reviews are from one year ago, in some embodiments, they will have 80% of the weight when compared to another equally weighted user who has three vegan restaurant reviews written within the past two months. In some embodiments, sequential reviews over time of the same or a similar product, business, or service are given differing weights. As a non-limiting example, as an alternate description of the subject matter depicted in FIG. 1, if Miguel reviewed the same restaurant one year ago and again one month ago, their combined weight are greater than the sum of two mutually exclusive reviews from different users. In some embodiments, the greater weight is assigned because it is likely Miguel has gained greater expertise in the product, business, or service and thus his sequential reviews will be more trustworthy and/or more influential.

### Weighted Review Generation

In some embodiments, provided herein are platforms, systems, media, and methods to generate a weighted review score, a total weighted review score, and/or a rating based on one or more vote weights assigned to a vote, or use of the same. In some embodiments, a vote of a review is assigned one vote weight and a weighted review score is generated based on the one vote weight. In some embodiments, a vote of a review is assigned two vote weights and a weighted review score is generated based on one or more of the two vote weights. In various embodiments, at least two vote weights are combined to generate the weighted review score. In some embodiments, a vote of a review is assigned three vote weights and a weighted review score is generated based on one or more of the three vote weights. In various embodiments, at least two vote weights are combined to generate the weighted review score. In some embodiments, a vote of a review is assigned four vote weights and a weighted review score is generated based on one or more of the four vote weights. In various embodiments, at least two vote weights are combined to generate the weighted review score. In some embodiments, a vote of a review is assigned five vote weights and a weighted review score is generated based on one or more of the five vote weights. In various embodiments, at least two vote weights are combined to generate the weighted review score. In some embodiments, a vote of a review is assigned six vote weights and a weighted review score is generated based on one or more of the six vote weights. In various embodiments, at least two vote weights are combined to generate the weighted review score. In some embodiments, a vote of a review is assigned seven vote weights and a weighted review score is generated based on one or more of the seven vote weights. In various embodiments, at least two vote weights are combined to generate the weighted review score. In some embodiments, a vote of a review is assigned eight vote weights and a weighted review score is generated based on one or more of the eight vote weights. In various embodiments, at least two vote weights are combined to generate the weighted review score. In some embodiments, a vote of a review is assigned nine vote weights and a weighted review score is generated based on one or more of the nine vote weights. In various embodiments, at least two vote weights are combined to generate the weighted review score. In some embodiments, a vote of a review is assigned ten vote weights and a weighted review score is generated based on one or more of the ten vote weights. In various embodiments, at least two vote weights are combined to generate the weighted review score. In some embodiments, a vote of a review is assigned a plurality vote weights and a weighted review score is generated based on one or more of the plurality vote weights. In various embodiments, at least two vote weights are combined to generate the weighted review score. In some embodiments, combining at least two vote weights comprises adding the at least two vote weights, subtracting the at least two vote weights, multiplying the at least two vote weights, dividing the at least two vote weights, or a combination thereof. In some embodiments, combining at least two vote weights comprises applying a mathematical function to one or more of the at least two vote weights. As a non-limiting example an exponential function, a logarithmic function, or a polynomial function is applied to one or more of the at least two vote weights.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned one vote weight. In various embodiments, a weighted review score is generated for each vote based on the vote weight assigned to the vote. In various embodiments, a total weighted review score for the review is generated by combining one or more of the weighted review scores for each of the plurality of votes.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned two vote weights. In various embodiments, a weighted review score is generated for each vote based on the two vote weights assigned to the vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned three vote weights. In various embodiments, a weighted review score is generated for each vote based on the three vote weights assigned to the vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned four vote weights. In various embodiments, a weighted review score is generated for each vote based on the four vote weights assigned to the vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned five vote weights. In various embodiments, a weighted review score is generated for each vote based on the five vote weights assigned to the vote. In some embodiments, the weighted review score for each vote is generated by combining at least two vote weights assigned to each vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned six vote weights. In various embodiments, a weighted review score is generated for each vote based on the six vote weights assigned to the vote. In some embodiments, the weighted review score for each vote is generated by combining at least two vote weights assigned to each vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned seven vote weights. In various embodiments, a weighted review score is generated for each vote based on the seven vote weights assigned to the vote. In some embodiments, the weighted review score for each vote is generated by combining at least two vote weights assigned to each vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned eight vote weights. In various embodiments, a weighted review score is generated for each vote based on the eight vote weights assigned to the vote. In some embodiments, the weighted review score for each vote is generated by combining at least two vote weights assigned to each vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned nine vote weights. In various embodiments, a weighted review score is generated for each vote based on the nine vote weights assigned to the vote. In some embodiments, the weighted review score for each vote is generated by combining at least two vote weights assigned to each vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned ten vote weights. In various embodiments, a weighted review score is generated for each vote based on the ten vote weights assigned to the vote. In some embodiments, the weighted review score for each vote is generated by combining at least two vote weights assigned to each vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, each of the plurality of votes is assigned a plurality of vote weights. In various embodiments, a weighted review score is generated for each vote based on the plurality of vote weights assigned to the vote. In some embodiments, the weighted review score for each vote is generated by combining at least two vote weights assigned to each vote. In some embodiments, the weighted review score for each vote is generated by combining at least two vote weights assigned to each vote. In various embodiments, combining the at least two vote weights comprises adding the at least two vote weights, subtracting the at least two vote weights, multiplying the at least two vote weights, dividing the at least two vote weights, or a combination thereof. In some embodiments, the at least two vote weights are combined using a mathematical function, for example, a logarithmic function, or a polynomial function. In various embodiments, a total weighted review score for the review is generated by combining one or more of the weighted review scores generated for each of the plurality of votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, one or more of the weighted review scores are combined using a mathematical function, for example an exponential function, a logarithmic function, or a polynomial function.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, one or more of the plurality of votes is assigned one or more vote weights. In various embodiments, for each vote assigned one or more vote weights, a weighted review score is generated based on the one or more vote weights assigned to the vote. In various embodiments, generating the weighted review score based on the one or more vote weights comprises adding the one or more vote weights, subtracting the one or more vote weights, multiplying the one or more vote weights, dividing the one or more vote weights, or a combination thereof. In some embodiments, generating the weighted review score based on the one or more vote weights comprises applying a mathematical function to one or more of the vote weights. As a non-limiting example an exponential function, a logarithmic function, or a polynomial function is applied to one or more of the vote weights.

In some embodiments, provided herein are platforms, systems, media, and methods to generate a weighted review score, a total weighted review score, and/or a rating based on one or more vote weights assigned to a vote, or use of the same. In some embodiments, a plurality of users vote on a review. In various embodiments, one or more of the plurality of votes is assigned one or more vote weights. In some embodiments, for each vote assigned two or more vote weights, the weighted review score is generated by combining at least two vote weights. In various embodiments, combining the at least two vote weights comprises adding the at least two vote weights, subtracting the at least two vote weights, multiplying the at least two vote weights, dividing the at least two vote weights, or a combination thereof. In some embodiments, combining the two vote weights comprises applying a mathematical function to one or more of the at least two vote weights. As a non-limiting example an exponential function, a logarithmic function, or a polynomial function is applied to one or more of the two vote weights. In various embodiments, a total weighted review score for the review is generated by combining the weighted review scores generated for one or more of the votes. In various embodiments, combining one or more of the weighted review scores comprises adding one or more of the weighted review scores, subtracting one or more of the weighted review scores, multiplying one or more of the weighted review scores, dividing one or more of the weighted review scores, or a combination thereof. In some embodiments, combining at least two vote weights comprises applying a mathematical function to one or more of the weighted review scores. As a non-limiting example an exponential function, a logarithmic function, or a polynomial function is applied to one or more of the weighted review scores.

In some embodiments, provided herein are platforms, systems, media, and methods to generate a weighted review score, a total weighted review score, and/or a rating based on one or more vote weights assigned to a vote, or use of the same. In some embodiments, a product, business, or service receives a plurality of reviews. In various embodiments, a weighted review score is generated for one or more of the plurality of reviews. In various embodiments, a total weighted review score is generated for one or more of the plurality of reviews. In various embodiments, a rating for a product, business, or service is generated by combining one or more of the weighted review scores of reviews for which a weighted review score is generated. In various embodiments, one or more of the weighted review scores are weighted to generate a rating of the product, business, or service. In various embodiments, weighting of one or more of the weighted review scores is based on a length of time since the weighted review score was changed, a number of views of the review to which the weighted review score is assigned, and a popularity of the product, business, or service. In various embodiments, popularity of the product, business, or service increases as the number of reviews and/or votes of the product, business, or service increases. In some embodiments, a product, business, or service with a high rating will be displayed closer to the top of a webpage than a product, business, or service with a lower rating.

In some embodiments, provided herein are platforms, systems, media, and methods to generate a weighted review score, a total weighted review score, and/or a rating based on one or more vote weights assigned to a vote, or use of the same. In some embodiments, a product, business, or service receives a plurality of reviews. In various embodiments, a weighted review score is generated for one or more of the plurality of reviews. In various embodiments, a total weighted review score is generated for one or more of the plurality of reviews. In various embodiments, a rating for a product, business, or service is generated by combining one or more of the total weighted review scores of the reviews for which a total weighted review score is generated. In various embodiments, one or more of the total weighted review scores are weighted to generate a rating of the product, business, or service. In various embodiments, weighting of one or more of the total weighted review scores is based on a length of time since the total weighted review score was changed, a number of views of the review to which the total weighted review score is assigned, a popularity of the product, business, or service, and a number of review submitted for the product, business, or service. In various embodiments, popularity of the product, business, or service increases as the number of reviews and/or votes of the product, business, or service increases. In some embodiments, a product, business, or service with a high rating will be displayed closer to the top of a webpage than a product, business, or service with a lower rating.

In some embodiments, provided herein are platforms, systems, media, and methods to generate a weighted review score, a total weighted review score, and/or a rating based on one or more vote weights assigned to a vote, or use of the same. In some embodiments, a product, business, or service receives a plurality of reviews. In various embodiments, a weighted review score is generated for one or more of the plurality of reviews. In various embodiments, a total weighted review score is generated for one or more of the plurality of reviews. In various embodiments, a rating for a product, business, or service is generated by combining one or more of the weighted review scores of the reviews for which a weighted review score is generated and one or more of the total weighted review scores of the reviews for which a total weighted review score is generated. In various embodiments, one or more of the weighted review scores and/or the total weighted review scores are weighted to generate a rating of the product, business, or service. In various embodiments, weighting of one or more of the weighted review scores and/or one or more of total weighted review scores is based on a length of time since the weighted review scores and/or one or more of total weighted review score was changed, a number of views of the review to which the weighted review scores and/or total weighted review score is assigned, and a popularity of the product, business, or service. In various embodiments, popularity of the product, business, or service increases as the number of reviews and/or votes of the product, business, or service increases. In some embodiments, a product, business, or service with a high rating will be displayed closer to the top of a webpage than a product, business, or service with a lower rating.

In some embodiments, provided herein are platforms, systems, media, and methods to generate a weighted review score, a total weighted review score, and/or a rating based on one or more vote weights assigned to a vote, or use of the same. In some embodiments, a person receives a plurality of reviews. In various embodiments, a weighted review score is generated for one or more of the plurality of reviews. In various embodiments, a total weighted review score is generated for one or more of the plurality of reviews. In various embodiments, a rating for a person is generated by combining one or more of the weighted review scores of reviews for which a weighted review score is generated. In various embodiments, one or more of the weighted review scores are weighted to generate a rating of the person. In various embodiments, weighting of one or more of the weighted review scores is based on a length of time since the weighted review score was changed, a number of views of the review to which the weighted review score is assigned, and a popularity of the person. In various embodiments, popularity of the person increases as the number of reviews and/or votes of the person increases. In some embodiments, a person with a high rating will be displayed closer to the top of a webpage than a person with a lower rating. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to generate a weighted review score, a total weighted review score, and/or a rating based on one or more vote weights assigned to a vote, or use of the same. In some embodiments, a person receives a plurality of reviews. In various embodiments, a weighted review score is generated for one or more of the plurality of reviews. In various embodiments, a total weighted review score is generated for one or more of the plurality of reviews. In various embodiments, a rating for a person is generated by combining one or more of the total weighted review scores of the reviews for which a total weighted review score is generated. In various embodiments, one or more of the total weighted review scores are weighted to generate a rating of the person. In various embodiments, weighting of one or more of the total weighted review scores is based on a length of time since the total weighted review score was changed, a number of views of the review to which the total weighted review score is assigned, a popularity of the person, and a number of reviews submitted for the person. In various embodiments, popularity of the person increases as the number of reviews and/or votes of the person increases. In some embodiments, a person with a high rating will be displayed closer to the top of a webpage than a person with a lower rating. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to generate a weighted review score, a total weighted review score, and/or a rating based on one or more vote weights assigned to a vote, or use of the same. In some embodiments, a person receives a plurality of reviews. In various embodiments, a weighted review score is generated for one or more of the plurality of reviews. In various embodiments, a total weighted review score is generated for one or more of the plurality of reviews. In various embodiments, a rating for a person is generated by combining one or more of the weighted review scores of the reviews for which a weighted review score is generated and one or more of the total weighted review scores of the reviews for which a total weighted review score is generated. In various embodiments, one or more of the weighted review scores and/or the total weighted review scores are weighted to generate a rating of the person. In various embodiments, weighting of one or more of the weighted review scores and/or one or more of total weighted review scores is based on a length of time since the weighted review scores and/or one or more of total weighted review score was changed, a number of views of the review to which the weighted review scores and/or total weighted review score is assigned, and a popularity of the person. In various embodiments, popularity of the person increases as the number of reviews and/or votes of the person increases. In some embodiments, a person with a high rating will be displayed closer to the top of a webpage than a person with a lower rating. In various embodiments, when the platforms, systems, media, and methods described herein, are configured to generate a weighted review score of a person, the person behaves like a person who is a product. In various embodiments, when the platforms, systems, media, and methods described herein, are configured to generate a weighted review score of a person, the person does not behave like a person who is a product.

In some embodiments, provided herein are platforms, systems, media, and methods to generate a weighted review score, a total weighted review score, and/or a rating based on one or more vote weights assigned to a vote, or use of the same. In some embodiments, a review with a high weighted review score will be displayed closer to the top of a webpage than a review with a lower weighted review score. In some embodiments, a review with a high weighted review score will be displayed closer to the top of a webpage than a review with a lower total weighted review score. In some embodiments, a review with a high total weighted review score will be displayed closer to the top of a webpage than a review with a lower weighted review score. In some embodiments, a review with a high total weighted review score will be displayed closer to the top of a webpage than a review with a lower total weighted review score.

In some embodiments, provided herein are platforms, systems, media, and methods to generate a weighted review score, a total weighted review score, and/or a rating based on one or more vote weights assigned to a vote, or use of the same. In some embodiments one or more weighted review scores are combined to generate a total weighted review score. In various embodiments, the total weighted review score is generated by comparing the sum of the vote weights assigned to a review to the sum of all vote weights assigned to all reviews of the same and/or a similar product, business or service. As a non-limiting example, product X in category Y is reviewed, and the total weighted review score of the review is calculated by comparing the sum of the vote weights assigned to the review to the sum of all vote weights assigned to product X in other reviews. As an additional non-limiting example, product X in category Y is reviewed, and the total weighted review score of the review is calculated by comparing the sum of the vote weights assigned to the review to the sum of all vote weights assigned to product X and all vote weights assigned to reviews of products in category Y. In some embodiments, the sum of all vote weights of product X is the weighted review score. In some embodiments, the sum of all vote weights in other reviews of product X is the sum of all weighted review scores of all other reviews of product X. In some embodiments, the sum of all vote weights in other reviews of products in category Y is the sum of all weighted review scores of all other reviews of products in category Y. In various embodiments, an exponential, a logarithmic, or a polynomial mathematical function is applied to the weighted review score, the total weighted review score, and/or one or more of the comparisons described above. In some embodiments of the aforementioned examples, product X is substituted for a business A and category Y is substituted for category B, wherein business A is in category B. In some embodiments of the aforementioned examples, product X is substituted for a service M and category Y is substituted for category N, wherein service M is in category N. In some embodiments of the aforementioned examples, product X is substituted for a person O and category Y is substituted for category P, wherein person O is in category P.

In some embodiments, provided herein are platforms, systems, media, and methods to generate a weighted review score, a total weighted review score, and/or a rating based on one or more vote weights assigned to a vote, or use of the same. In some embodiments, comparing comprises calculating a percent weight assigned to the review. As a non-limiting example, product X in category Y is reviewed, and the total weighted review score of the review is calculated by dividing the sum of the vote weights assigned to the review by the sum of all vote weights assigned to product X in other reviews and multiplying the quotient by 100. As an additional non-limiting example, product X in category Y is reviewed, and the total weighted review score of the review is calculated by dividing the sum of the vote weights assigned to the review by the sum of all vote weights assigned to product X and all vote weights assigned to reviews of products in category Y and multiplying the quotient by 100. In some embodiments, the sum of all vote weights in other reviews of product X is the sum of all weighted review scores of all other reviews of product X. In some embodiments, the sum of all vote weights of product X is the weighted review score. In some embodiments, the sum of all vote weights in other reviews of products in category Y is the sum of all weighted review scores of all other reviews of products in category Y. In various embodiments, an exponential, a logarithmic, or a polynomial mathematical function is applied to the weighted review score, the total weighted review score, and/or one or more of the quotients described above. In some embodiments of the aforementioned examples, product X is substituted for a business A and category Y is substituted for category B, wherein business A is in category B. In some embodiments of the aforementioned examples, product X is substituted for a service M and category Y is substituted for category N, wherein service M is in category N. In some embodiments of the aforementioned examples, product X is substituted for a person O and category Y is substituted for category P, wherein person O is in category P.

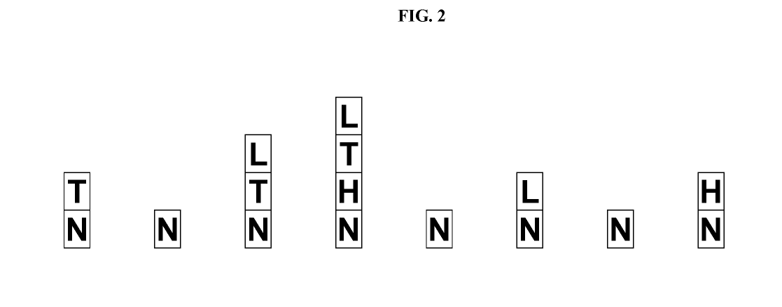

In some embodiments, provided herein are platforms, systems, media, and methods to generate a weighted review score, a total weighted review score, and/or a rating based on one or more vote weights assigned to a vote, or use of the same. A non-limiting example of the platforms, systems, methods and media described herein is depicted in FIG. 2 and Example 2.

In some embodiments, provided herein are platforms, systems, media, and methods to generate a weighted review score, a total weighted review score, and/or a rating based on one or more vote weights assigned to a vote, or use of the same. In some embodiments, relative vote weights are not equal. As a non-limiting example, in some embodiments, a first vote weight is equal to 50% of the value of a second vote weight, 300% of the value of a second vote weight, or −50% of the value of a second vote weight. In some embodiments, any positive or negative value may be assigned to one vote weight to assign it a relative weight based on another vote weight. In some embodiments, multiple values are assigned to each vote weight depending on the user. As a non-limiting example, a vote weight has a value of 1 for one user and 0.8 for another user.

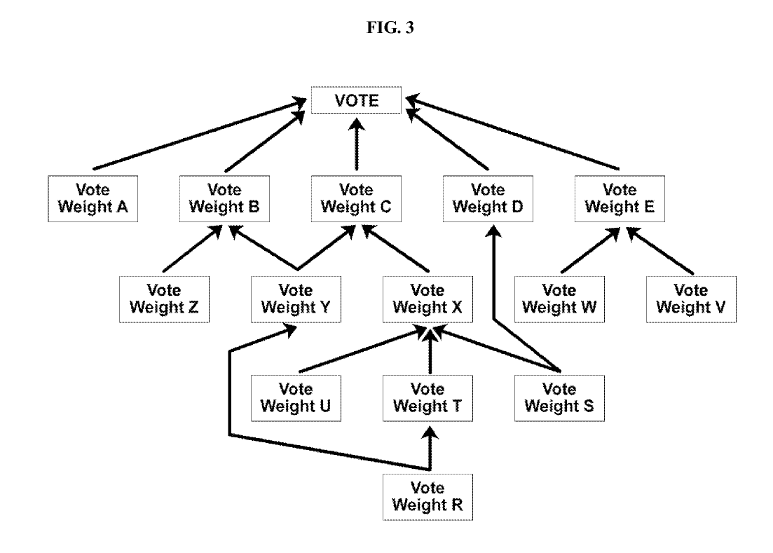

In some embodiments, provided herein are platforms, systems, media, and methods to generate a weighted review score, a total weighted review score, and/or a rating based on one or more vote weights assigned to a vote, or use of the same. In some embodiments, vote weights are nested and dependent upon parent variables. In some embodiments, subsets of vote weights are nested and dependent upon parent variables. A non-limiting example of the platforms, systems, methods and media described herein is depicted in FIG. 3. As depicted in FIG. 3, in some embodiments a vote is assigned a weighted review score, wherein the weighted review score is determined from a plurality of vote weights. In FIG. 3, the weighted review score of the vote is determined from vote weights A, B, C, D, and E. Further, as depicted in FIG. 3, one or more of the vote weights A, B, C, D, and E are nested and determined based on other nested vote weights, for example:
vote weight A is calculated based on its inherent vote weight and is not dependent on any nested vote weights;
vote weight B is calculated based on its inherent weight and vote weights Z and Y, which are nested vote weights of B;
vote weight Y is calculated based on its inherent weight and vote weight R, which is a nested vote weight of Y;
vote weight Z is calculated based on its inherent vote weight and is not dependent on any nested vote weights;
vote weight C is calculated based on its inherent weight and vote weight Y and X, which are nested vote weights of C;
vote weight X is calculated based on its inherent vote weights and vote weights U, T, and S, which are nested vote weights of X;
vote weight S is calculated based on its inherent vote weight and is not dependent on any nested vote weights;
vote weight U is calculated based on its inherent vote weight and is not dependent on any nested vote weights;
vote weight T is calculated based on its inherent vote weights and vote weight R, which is a nested vote weight of T;
vote weight R is calculated based on its inherent vote weight and is not dependent on any nested vote weights
vote weight D is calculated based on its inherent vote weight and vote weight S, which is a nested vote weight of D;
vote weight E is calculated based on its inherent vote weight and vote weights W and V, which are nested vote weights of E;
vote weight W is calculated based on its inherent vote weight and is not dependent on any nested vote weights; and
vote weight V is calculated based on its inherent vote weight and is not dependent on any nested vote weights.

In some embodiments, combining two or more vote weights comprises adding the two or more vote weights, subtracting the at least two vote weights, multiplying the at least two vote weights, dividing the at least two vote weights, or a combination thereof. In some embodiments, combining two or more vote weights comprises applying a mathematical function to one or more of the vote weights. As a non-limiting example an exponential function, a logarithmic function, or a polynomial function is applied to one or more of the at least two vote weights. In some embodiments, the mathematical function comprises addition, subtraction, multiplication, and/or division. In some embodiments, more than one mathematical function is applied to the two or more vote weights. In some embodiments, more than one mathematical function is applied to the two or more vote weights. As a non-limiting example two or more vote weights are added, subtracted, multiplied, and/or divided and a logarithmic function is applied. In some embodiments, calculating a vote weight when the vote weight has nested vote weights comprises adding, subtracting, multiplying, and/or dividing any combination of the inherent vote weight and the nested vote weights. In some embodiments, calculating a vote weight wherein the vote weight has nested vote weights comprises applying a mathematical function to one or more of the inherent vote weights and the nested vote weights. As a non-limiting example an exponential function, a logarithmic function, or a polynomial function is applied to one or more of the inherent vote weights and the nested vote weights. In some embodiments, the mathematical function comprises addition, subtraction, multiplication, and/or division. In some embodiments, more than one mathematical function is applied to one or more of the inherent vote weights and the nested vote weights. As a non-limiting example, one or more of the inherent vote weights and the nested vote weights are added, subtracted, multiplied, and/or divided and a logarithmic function is applied.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, vehicles, and wearable computing devices. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art. Those of skill in the art will recognize wearable computing devices suitable to work with the platforms, systems, media, and methods described herein comprise a smart watch, smart glasses (e.g., Google Glass®, Microsoft HoloLens®), clothing comprising computing devices, and any other computing device that can be attached to or worn by a person and/or animal.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In various embodiments, the input device is a device capable of recognizing one or more physical gestures and/or motions. In further embodiments, the input device is a Microsoft Kinect®, Leap Motion®, or the like. In still further embodiments, the input device is a combination of devices such as those disclosed herein.

### Server Configuration

In some embodiments, a suitable server configuration includes about 1, about 2, about 3, about 4, about 5, about 6, about 7, about 8, about 9, about 10, about 20, about 30, about 40, about 50, about 60, about 70, about 80, about 90, about 100, about 200, about 500, about 1000, more than about 1000 servers, one or more server farms, and cloud-based server resource allocation systems. In some embodiments, the servers are co-located. In some embodiments, the servers are located in different geographical locations. In some embodiments the servers are housed in the same rack. In some embodiments, the servers are housed in multiple racks. In some embodiments, the multiple racks are in the same geographic region. In some embodiments the racks are in different geographic regions. In some embodiments, the server is or a plurality of servers employ a software framework such as Hadoop, Google MapReduce, HBase, and/or Hive, for storage and large-scale processing of data-sets on clusters of hardware.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. As a non-limiting example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of item, buyer, and seller information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Example 1

### Assignment of Influence/Trust

As depicted in the non-limiting example of FIG. 1, vote weights are assigned based on one or more relationships and/or endorsements. As a non-limiting example, when a user and/or a review submitted by a user is endorsed (e.g., voted in favor of, received a positive opinion, and/or received a positive emotion) by a more “trusted” user, some or all of that “trust” is passed along to the user and/or the review. Each circle represents a user and, and the size of each circle represents the user's influence and/or trust that has been gained as described above. In this non-limiting example: (1) Jen's circle is the smallest since she has not yet participated by endorsing another user and/or another review; (2) the circles of Fred, Amy, Mark, Lee, Noah, and Peter are of identical size, as each user has participated by endorsing one or more other users and/or one or more other reviews; (3) Aki's circle is the next size up, since her and/or her review(s) have been endorsed by Lee and Noah; (4) Miguel's circle is bigger than Aki's, since Miguel and/or his review(s) have been endorsed by Fred, Amy, and Mark; (5) Rebecca's circle is bigger than Miguel's, since her and/or her review(s) have been endorsed by Lee, Noah, Peter, and Mark; (6) Tom's circle is the same size as Rebecca's because although him and/or his review(s) only have one endorsement, that endorsement comes from Lynn, the most influential and/or the most trusted user; and (7) Lynn's circle is the most influential indicating she has the most trust since Rebecca, Mark, and Aki endorse her and/or her review(s). In this non-limiting example, the three endorsements and/or votes coming to Miguel are for his reviews of vegan restaurants, while Lynn only has 1 endorsement for vegan restaurants. Thus, although Miguel's has less overall influence than Lynn, Miguel's influence for vegan restaurants is weighed more heavily than Lynn's, due to Miguel having a higher calculated weight for vegan restaurants.

### Example 2

### Assignment of Vote Weights

As depicted in the non-limiting example of FIG. 2, eight different reviews are depicted, one review per column, with corresponding votes based on each of the eight reviews. All eight reviews are for a particular product, business, or service. In the non-limiting example, N is a “normal” vote, L is an a weight based on the length of time the user providing the vote has been a participant of the website and/or web service, H is a vote weight based on the history and/or pattern of votes from the user providing the votes, and T is a weight based on the total number of reviews the user providing the vote has contributed. In this non-limiting example, the weighted review score of the 4^{th} review from the left is four. In this non-limiting example, the total weighted review score of each review is calculated as: (sum of votes for a particular review/sum of all votes from all reviews)=total weighted review score. As a non-limiting example, assuming each square represents a vote weight of one, the 4th review from the left, which contains 4 squares (L, T, H, and N) has a total weighted review of ( 4/16)=0.25. Thus, the total weighted review score for the 4^{th} review from the left is 25% (0.25*100) of all votes provided for the particular product, business, or service. As such, in this non-limiting example, the 4^{th} review from the left has the largest weighted review score.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A computer-implemented system to generate a weighted review score of a product, business, or service comprising:
a) a digital processing device comprising: at least one processor, an operating system configured to perform executable instructions, and a memory; and
b) a computer program including instructions executable by the digital processing device, the instructions, when executed by the digital processing device, cause the digital processing device to:
i) receive a review of a product, business, or service from a first user, the review comprising an evaluation of the product, business, or service;
ii) display the review;
iii) receive a vote on the review from a second user;
iv) assign the vote a plurality of vote weights based on a voting credential of the second user, wherein the plurality of vote weights comprises at least one of:
1. a vote weight based on whether the second user previously reviewed the same or a similar product, business, or service;
2. a vote weight based on a length of time since the second user reviewed the same or a similar product, business, or service;
3. a vote weight based on a number of times the second user reviewed the same or a similar product, business, or service;
4. a vote weight based on a percentage of votes submitted by the second user to the same or a similar product, business, or service;
5. a vote weight based on a voting pattern or a review pattern of the second user;
6. a vote weight based on a number of votes received by one or more additional reviews submitted by the second user;
7. a vote weight based on a length of time the second user has been voting;
8. a vote weight based on a frequency of votes submitted by the second user to the product, business, or service;
9. a vote weight based on whether the second user is a verified user; and
10. a vote weight based on a total number of votes submitted by the second user;
v) combine the plurality of vote weights; and
vi) generate the weighted review score of the product, business, or service.

2. The computer-implemented system to generate a weighted review score of a product, business, or service of claim 1, wherein one or more of the plurality of vote weights are nested.

3. The computer-implemented system to generate a weighted review score of a product, business, or service of claim 2, wherein the software module configured to receive a vote on the review from a second user is configured to receive a vote on the review from a plurality of users.

4. The computer-implemented system to generate a weighted review score of a product, business, or service of claim 3, wherein the software module configured to combine the plurality of vote weights to generate the weighted review score of the product, business, or service, combines the plurality of vote weights assigned to each vote to generate a weighted review score of each vote.

5. The computer-implemented system to generate a weighted review score of a product, business, or service of claim 4, comprising a software module configured to combine the weighted review score of each vote to generate a total weighted review score of the product, business, or service.

6. The computer-implemented system to generate a weighted review score of a product, business, or service of claim 5, wherein combining the weighted review score of each vote comprises applying a logarithmic function to at least a group of weighted review scores.

7. A computer-implemented system to generate a weighted review score of a product, business, or service comprising:
a) a digital processing device comprising: at least one processor, an operating system configured to perform executable instructions, and a memory;
b) a computer program including instructions executable by the digital processing device, the instructions, when executed by the digital processing device, cause the digital processing device to:
i) receive a review of a product, business, or service from a first user, the review comprising an evaluation of the product, business, or service;
ii) display the review;
iii) receive a vote on the review from a second user;
iv) assign the vote a vote weight; and
v) generate the weighted review score of the product, business, or service based on the vote weight.

8. The computer-implemented system to generate a weighted review score of a product, business, or service of claim 7, wherein the vote weight comprises at least one of:
a) a vote weight based on whether the second user previously reviewed the same or a similar product, business, or service;
b) a vote weight based on a length of time since the second user reviewed the same or a similar product, business, or service;
c) a vote weight based on a number of times the second user reviewed the same or a similar product, business, or service;
d) a vote weight based on a percentage of votes submitted by the second user to the same or similar product, business, or service;
e) a vote weight based on a voting pattern or a review pattern of the second user;
f) a vote weight based on a number of votes received by one or more additional reviews submitted by the second user;
g) a vote weight based on a length of time the second user has been voting;
h) a vote weight based on a frequency of votes submitted by the second user to the product, business, or service;
i) a vote weight based on whether a measured relationship exists;
j) a vote weight based on whether the second user is a verified user; and
k) a vote weight based on a total number of votes submitted by the second user.

9. The computer-implemented system to generate a weighted review score of a product, business, or service of claim 7, wherein the software module configured to assign the vote a vote weight, assigns a plurality of vote weights to the vote.

10. The computer-implemented system to generate a weighted review score of a product, business, or service of claim 9, wherein the plurality of vote weights comprises at least one of:
a) a vote weight based on whether the second user previously reviewed the same or a similar product, business, or service;
b) a vote weight based on a length of time since the second user reviewed the same or a similar product, business, or service;
c) a vote weight based on a number of times the second user reviewed the same or a similar product, business, or service;
d) a vote weight based on a percentage of votes submitted by the second user to the same or a similar product, business, or service;
e) a vote weight based on a voting pattern or a review pattern of the second user;
f) a vote weight based on a number of votes received by one or more additional reviews submitted by the second user;
g) a vote weight based on a length of time the second user has been voting;
h) a vote weight based on a frequency of votes submitted by the second user to the product, business, or service;
i) a vote weight based on whether the second user is in a measured relationship;
j) a vote weight based on whether the second user is a verified user; and
k) a vote weight based on a total number of votes submitted by the second user.

11. The computer-implemented system to generate a weighted review score of a product, business, or service of claim 9, wherein one or more of the plurality of vote weights are nested.

12. The computer-implemented system to generate a weighted review score of a product, business, or service of claim 9, wherein the plurality of vote weights are combined to generate the weighted review score.

13. The computer-implemented system to generate a weighted review score of a product, business, or service of claim 7, wherein the software module configured to receive a vote on the review from a second user is configured to receive a vote on the review from a plurality of users.

14. The computer-implemented system to generate a weighted review score of a product, business, or service of claim 13, wherein the software module configured to assign the vote a vote weight, assigns each vote a vote weight.

15. The computer-implemented system to generate a weighted review score of a product, business, or service of claim 14, wherein the vote weight comprises at least one of:
a) a vote weight based on whether a voting user previously reviewed the same or a similar product, business, or service;
b) a vote weight based on a length of time since a voting user reviewed the same or a similar product, business, or service;
c) a vote weight based on a number of times a voting user reviewed the same or a similar product, business, or service;
d) a vote weight based on a percentage of votes submitted by a voting user to the same or a similar product, business, or service;
e) a vote weight based on a voting pattern or a review pattern of a voting user;
f) a vote weight based on a number of votes received by one or more additional reviews submitted by a voting user;
g) a vote weight based on a length of time a voting user has been voting;
h) a vote weight based on a frequency of votes submitted by a voting user to the product, business, or service;
i) a vote weight based on whether a voting user is in a measured relationship;
j) a vote weight based on whether a voting user is a verified user; and
k) a vote weight based on a total number of votes submitted by a voting user.

16. The computer-implemented system to generate a weighted review score of a product, business, or service of claim 14, wherein the software module configured to generate the weighted review score of the product, business, or service, generates a weighted review score for each vote based on the vote weight.

17. The computer-implemented system to generate a weighted review score of a product, business, or service of claim 16, comprising a software module configured to combine the weighted review score of each vote to generate a total weighted review score of the product, business, or service.

18. The computer-implemented system to generate a weighted review score of a product, business, or service of claim 17, wherein combining the weighted review score of each vote comprises applying a logarithmic function to at least a group of weighted review scores.

19. The computer-implemented system to generate a weighted review score of a product, business, or service of claim 13, wherein the software module configured to assign the vote a vote weight, assigns a plurality of vote weights to each vote received from the plurality of users.

20. The computer-implemented system to generate a weighted review score of a product, business, or service of claim 19, wherein the plurality of vote weights assigned to each vote comprises at least one of:
a) a vote weight based on whether a voting user previously reviewed the same or a similar product, business, or service;
b) a vote weight based on a length of time since a voting user reviewed the same or a similar product, business, or service;
c) a vote weight based on a number of times a voting user reviewed the same or a similar product, business, or service;
d) a vote weight based on a percentage of votes submitted by a voting user to the same or a similar product, business, or service;
e) a vote weight based on a voting pattern or a review pattern of a voting user;
f) a vote weight based on a number of votes received by one or more additional reviews submitted by a voting user;
g) a vote weight based on a length of time a voting user has been voting;
h) a vote weight based on a frequency of votes submitted by a voting user to the product, business, or service;
i) a vote weight based on whether a voting user is in a measured relationship;
j) a vote weight based on whether a voting user is a verified user; and
k) a vote weight based on a total number of votes submitted by a voting user.

21. The computer-implemented system to generate a weighted review score of a product, business, or service of claim 19, wherein one or more of the plurality of vote weights are nested.

22. The computer-implemented system to generate a weighted review score of a product, business, or service of claim 19, wherein the plurality of vote weights are combined to generate the weighted review score for each vote.

23. The computer-implemented system to generate a weighted review score of a product, business, or service of claim 22, comprising a software module configured to combine the weighted review score of each vote to generate a total weighted review score of the product, business, or service.

24. The computer-implemented system to generate a weighted review score of a product, business, or service of claim 23, wherein combining the weighted review score of each vote comprises applying a logarithmic function to at least a group of weighted review scores.

25. A computer-implemented system to generate a weighted review score of a product, business, or service comprising:
a) a digital processing device comprising: at least one processor, an operating system configured to perform executable instructions, and a memory;
b) a computer program including instructions executable by the digital processing device, the instructions when executed by the digital processing device, cause the digital processing device to:
i) receive a review of a product, business, or service from a first user, the review comprising an evaluation of the product, business, or service;
ii) display the review;
iii) receive a vote on the review from a plurality of users;
iv) assign each vote received from the plurality of users a plurality of vote weights, wherein one or more of the plurality of vote weights are nested, and wherein the plurality of vote weights comprises at least one of:
1. a vote weight based on whether a voting user previously reviewed the same or a similar product, business, or service;
2. a vote weight based on a length of time since a voting user reviewed the same or a similar product, business, or service;
3. a vote weight based on a number of times a voting user reviewed the same or a similar product, business, or service;
4. a vote weight based on a percentage of votes submitted by a voting user to the same or a similar product, business, or service;
5. a vote weight based on a voting pattern or a review pattern of a voting user;
6. a vote weight based on a number of votes received by one or more additional reviews submitted by a voting user;
7. a vote weight based on a length of time a voting user has been voting;
8. a vote weight based on a frequency of votes submitted by a voting user to the product, business, or service;
9. a vote weight based on whether a voting user is a verified user; and
10. a vote weight based on a total number of votes submitted by a voting user;
v) combine the plurality of vote weights assigned to each vote received from the plurality of users to generate the weighted review score of the product, business, or service for each vote received from the plurality of users;
vi) combine the weighted review score of each vote received from the plurality of users; and
vii) to generate a total weighted review score of the product, business, or service.

26-30. (canceled)

31. A method for generating a weighted review score of a product, business, or service, the method comprising:
i. receiving, by a computer, a review of a product, business, or service from a first user, the review comprising an evaluation of the product, business, or service;
ii. displaying, by the computer, the review;
iii. receiving, by the computer, a vote on the review from a second user;
iv. assigning, by the computer, the vote a plurality of vote weights automatically based on voting credential of the second user, wherein one or more of the plurality of vote weights are nested, wherein the plurality of vote weights comprises at least one of:
1. a vote weight based on whether the second user previously reviewed the same or a similar product, business, or service;
2. a vote weight based on a length of time since the second user reviewed the same or a similar product, business, or service;
3. a vote weight based on a number of times the second user reviewed the same or a similar product, business, or service;
4. a vote weight based on a percentage of votes submitted by the second user to the same or a similar product, business, or service;
5. a vote weight based on a voting pattern or a review pattern of the second user;
6. a vote weight based on a number of votes received by one or more additional reviews submitted by the second user;
7. a vote weight based on a length of time the second user has been voting;
8. a vote weight based on a frequency of votes submitted by the second user to the product, business, or service;
9. a vote weight based on whether the second user is a verified user; and
10. a vote weight based on a total number of votes submitted by the second user;
v. combining, by the computer, the plurality of vote weights; and
vi. generating, by the computer, the weighted review score of the product, business, or service.

32. The method of claim 31, wherein one or more of the plurality of vote weights are nested.
